(19) United States
(12) Patent Application Publication
(10) Pub. No.: US 2009/0144175 A1
(43) Pub. Date: Jun. 4, 2009

(54) SYSTEM AND METHOD FOR GENERATING SELF-HELP CUTTING INSTRUCTIONS OF DECORATIVE TRIM

(76) Inventor: Ronaldo G. Penaflor, Fallbrook, CA (US)

Correspondence Address: RONALDO G. PENAFLOR, 1160 VANTAGE PLACE, FALLBROOK, CA, 92028, US

(21) Appl. No.: 12/263,488

(22) Filed: Nov. 2, 2008

Related U.S. Application Data
(60) Provisional application No. 60/991,311, filed on Nov. 30, 2007.

(51) Int. Cl. G06Q 30/00

(52) U.S. Cl. 705/27

(57) ABSTRACT

The present invention relates to a technique for efficient interior and decorative designs and more particularly to a system and process to determine a plurality of self-help cutting instructions of decorative trim, and to a method that simplifies the process of planning, cutting, installing, and estimating material requirements and costs related to decorative trim.

### PRIORITY CLAIMS AND RELATED APPLICATIONS

This application claims the benefit of priority of U.S. Provisional Application Ser. No. 60/991,311 filed Nov. 30, 2007, which is incorporated herein by reference.

### FIELD OF THE INVENTION

The present invention relates to a technique for efficient interior and decorative designs and more particularly to a system and process to determine a plurality of self-help cutting instructions of decorative trim, and to a method that simplifies the process of planning, cutting, installing, and estimating material requirements and costs related to decorative trim. Decorative trim includes, but is not limited to, crown molding, chair rails, wall-frames, cabinet molding, base boards, and any other type of decorative trim.

### BACKGROUND OF THE INVENTION

Decorative trim is widely used for interior and exterior decorative enhancements in both residential and commercial establishments. Examples of decorative trim for an interior wall includes but are not limited to chair rails, bead board, wall frames, base boards or any combination thereof. Similarly, examples of decorative trim for the ceiling include but are not limited to single crown, built-up crown, coffered ceilings, beams or any combination thereof. Decorative trim may also used to enhance stairs, cabinets, and shelves. An example of exterior decorative trim includes, but is not limited to decorative trim outlining a door or window, support column or wall enhancements.

For the average homeowner, the cost of adding decorative trim can be expensive, which is primarily due to the intensive labor costs and the requisite expertise involved in planning, cutting and installing the decorative trim. Alternatively, the home owner may opt to take on the task themselves and avoid the labor cost, thereby saving a significant portion of the total cost. Homeowner self-driven projects, also know as do-it-yourself projects, have several advantages, one of which is to minimize labor costs. Other advantages can include more control of time and resources, the appearance of the final product, and flexibility of the project such as choosing the grade of molding. However, for many do-it-yourself enthusiasts, taking on a project without a good plan of attack, requisite expertise, and understanding of costs can have many disadvantages such as paying too much for material or buying too much material, wasting material due to errors or miscalculations, not having the necessary equipment such as a miter saw or pneumatic nailer, or having to chose to either purchase or rent the equipment.

To address such problems, especially the lack of the requisite expertise, computer programs are available on the market that are used for calculating miter cut settings for a compound miter saw (also know as a cut list) and estimating materials needed as well as the cost of materials. These programs are often difficult to use, are not user friendly for the do-it-yourself enthusiast, and generally lack necessary instructions for self help decorative trim projects.

### SUMMARY OF THE INVENTION

The present invention overcomes the deficiencies of the prior art by providing a simple, yet efficient solution for planning, cutting, installing, estimating material requirements and costs, and equipment selections associated with interior design for decorative trim. The present invention may be used to a particular advantage in the context of generating a plurality of self-help instructions for the planning, cutting and installation of decorative trim. Specifically, these self-help instructions may include miter saw cutting instructions and settings for a plurality of walls. Self-help, in the context of this invention, is a term meaning the action or process of creating, improving, or repairing things performed by a do-it-yourself individual without the aid of others, for example, paid professionals.

In one implementation, steps include selecting one or more rooms; defining one or more walls for each of the one or more rooms; defining a plurality of adjacent wall angles, a plurality of wall object angles, a plurality of spring angles, and combinations thereof for each of the one or more walls; determining a plurality of angle settings based on the plurality of wall angles, plurality of wall object angles, a plurality of spring angles and combinations thereof for each of the one or more walls; and generating a plurality of self-help cutting instructions having the plurality of angle settings arranged by the one or more walls for each of the one or more rooms.

In another implementation, a system includes a computer or server capable of receiving inputs, wherein the inputs are comprised of a plurality of rooms, plurality of adjacent wall angles, a plurality of wall object angles, a plurality of spring angles, and combinations thereof; a database, coupled to the computer, for storing the inputs received by the computer or server; and a program operating on the computer or server capable of a) determining a plurality of angle settings based on the plurality of wall angles, plurality of wall object angles, a plurality of spring angles and combinations thereof for each of the one or more walls; and b) generating a plurality of self-help cutting instructions having the plurality of angle settings arranged by the one or more walls for each of the one or more rooms.

In another implementation, a software based application, computer program, or system may incorporate, but is not limited to the following twenty two features: 1) utilizes a simple, yet powerful, “user friendly” application; 2) provides both animated, video and graphical representation of the decorative trim; 3) features drag and drop functionality for quick and easy placement of decorative trim onto a work area; 4) provides for automatic trim width and height adjustments in accordance to room dimensions; 5) simulates trim joints in three-dimensional views; 6) provides a complete materials list used in the project; 7) provides a summary of cost estimates of the entire project based on the user's specification; 8) provides customized cutting and installation instructions based on the user's specification; 9) is web-based, i.e., Internet based; 10) supports an open library capable of being shared by others over a network, and is expandable; 11) supports and is compatible with networked servers to access a database in real-time, the database containing product information such as material price and quantity on hand, which results in accurate project cost and material availability estimates; 12) contains pre-defined decorative trim elements used for walls, ceilings, and façades, or other interior or exterior surfaces; 13) outputs to a screen, a printer, a storage medium, another computer, or to the internet, both numerical and graphical results of cross-cut, bevel angles settings, and cut list of peripheral materials, and other reports and lists; 14) provides animated or video instructional clips of miter settings; 15) provides a summary of cost estimates and material list of the entire project; 16) calculates the total cost and materials requirements using real-time pricing and availability of materials; 17) provides a checklist of power tools required to perform the job with an option to select tool types or brands, and an option to rent or purchase the tool, 18) ties a rental database, in real-time, of power tools to calculate additional cost if option to rent tools is selected; 19) determines and rates complexity of cuts based on a set of pre-determined factors; 20) determines and rates the complexity of the installation based on a set of pre-determined factors; 21) generates and outputs a project timeline of all cutting and installation steps based on user's specification; or 22) generates and outputs cutting and installations steps in multiple languages. In other embodiments of the invention, the software application may incorporate only a few of, or all of the twenty two features listed above, or additional features not listed but would be obvious to one skilled in the art.

The present invention may provide support for standard and non-standard room dimensions and wall angles that are ninety-degrees or less than ninety degrees or greater than ninety degree such that the do-it-yourself users are able to define room dimensions and wall angles that are suitable to their needs. Such dimensions and angles can be used as a basis for calculating dimensional lengths and cutting angles of all decorative trim. These dimensional lengths and cutting angles may be used to generate user interface views.

One advantage of the present invention is that it simplifies the process of selecting, pricing, and cutting decorative trim which may save time and may reduce the overall costs of the project. Cost estimates, availability of material and equipment rental may be performed in real-time and online.

Because the invention can be web-based, another advantage is that the present invention may be capable of sharing information with other computers and adding library decorative trim elements. Sharing libraries allows do-it-yourself users or other parties to define and upload decorative trim elements, as well as parameters associated with the elements such as the price per linear foot, product numbers, resources required, or any other relevant information.

Yet another advantage of the present invention is that in addition to a visual display, it can provide graphical outputs to files or other storage media such as, but not limited to, floppy disks, CDROM, DVD, BlueRay, tapes, Internet, other computers, or it may create immediate printouts of cross-cuts and bevel cuts or any other graphical outputs. In addition, animated or video demonstrations of how to set up the miter saw can be automatically generated based on the do-it-yourself user requirements, which can minimize the errors in cuts, and consequently reduces costs.

The foregoing and other features and advantages of the invention will be apparent from the following detailed description of the embodiments of the invention, the accompanying drawings, and the claims.

### BRIEF DESCRIPTION OF THE DRAWINGS

The present invention will be more clearly understood from the following detailed description of the preferred embodiments of the invention and from the attached drawings, in which:

FIGS. 1a and 1b illustrate the application flowcharts wherein FIG. 1a illustrates a basic three-step process and FIG. 1b illustrates a more detailed flowchart of the invention.

FIG. 2 illustrates the application flowchart of user interactions.

FIG. 3 illustrates the room selection screen.

FIGS. 4a-4e illustrates examples of a wall and ceiling dimension input and configuration screen for the living room wherein FIG. 4a is the living room's setup screen, FIG. 4b is one living room's wall dimension and angel data entry screen, FIG. 4c is a different living room's data entry screen, FIG. 4d is the configure walls entry screen, and FIG. 4e is the configure walls edit screen.

FIGS. 5a-5c illustrates the drag-and-drop screens wherein FIG. 5a illustrates the main drag-and-drop work area screen, FIG. 5b illustrates one wall of a living room and FIG. 5c illustrates a top view of the living room.

FIG. 6 illustrates the different area views.

FIG. 7 illustrates the crown molding library options screen.

FIG. 8 illustrates the ceiling option screen.

FIGS. 9a and 9b illustrate two option views wherein FIG. 9a illustrates the chair rail options screen and FIG. 9b illustrates the wall frame options screen.

FIG. 10 illustrates the bead board options screen.

FIG. 11 illustrates the base board options screen.

FIG. 12 illustrates the staircase options screen.

FIG. 13 illustrates the facade options screen.

FIG. 14 is a diagrammatic view of the application and network configurations between application and database server.

FIG. 15 illustrates the Report selection screen.

FIG. 16a-16e illustrates reports screens where FIG. 16a illustrates the miter cut list report, FIG. 16b is a side view of the spring angle, FIB. 16c is a graphical representation of a molding piece, FIG. 16d illustrates a top view of a compound miter saw and FIG. 16e illustrates the miter cut list report.

FIG. 17 illustrates the material and cost list report in text and graphical format.

FIG. 18 illustrates the skill level and complexity rating report required for cutting and installing decorative trim.

FIG. 19 illustrates the estimated cutting and installation time report.

FIG. 20 illustrates a project timeline report of all cutting and installation steps.

FIG. 21 illustrates the customized cutting instructions of decorative trim.

FIG. 22 illustrates the customized installation instructions of decorative trim.

FIG. 23 illustrates the product information report.

FIG. 24 illustrates the power tool rental option.

FIG. 25 illustrates a pre-defined façade element described in the Façade Library.

### DETAILED DESCRIPTION OF THE PREFERRED EMBODIMENTS

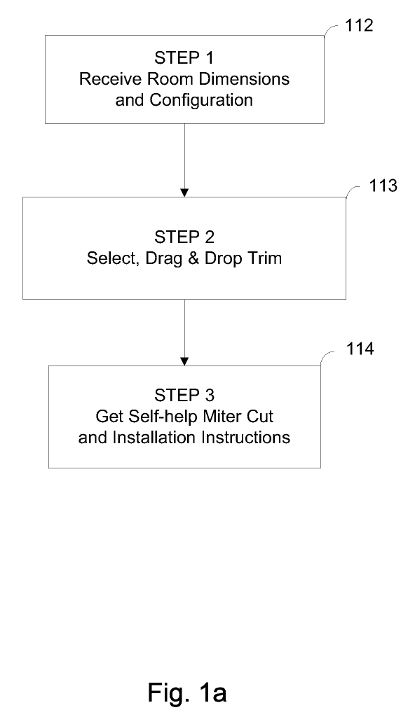

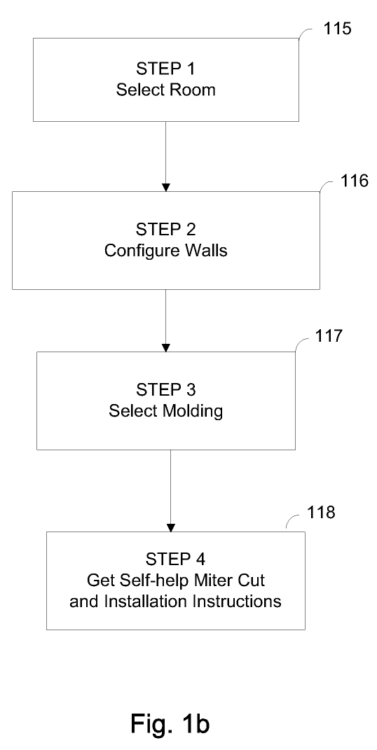

Embodiments of the present invention and their advantages may be understood by referring to FIGS. 1-25 and are described in the context decorative trim including, but not limited to chair rails, bead board, wall frames, base boards, single crown, built-up crown, coffered ceilings, beams or any combination thereof. However, the present invention is applicable to any forms of decorative trim. As a matter of terminology, the terms “decorative trim”, “trim” and “molding” may be used interchangeably. For the sake of simplicity, the following description is provided in the exemplary context of decorating a room with basic rectangular dimensions—four walls, 90 degrees right angles between walls. Nonetheless, the invention is applicable to rooms of any shape and dimensions including irregular dimensions and angles. It will be clear to those of ordinary skill in the art that a number of variations on the same theme are possible given the variety of decorative trim elements available to the artisan.

FIG. 1a illustrates a process of the present invention for adding custom decorative trim to a wall or ceiling for a given room. This process comprises three steps the user follows in order to achieve the desired miter cut settings, installation instructions, and material and cost estimates for adding custom decorative trim. In Step 1, Receive Room dimensions and Configure 112, the user selects one or more rooms, defines the respective room dimensions and then configures each room. In Step 2, Select, Drag & Drop Trim 113, the user selects the type of decorative trim and adds decorative trim by dragging and dropping the selected decorative trim objects onto a work area (room) defined in Step 1. In Step 3, Get Self-help Miter Cut and Installation Instructions 114, the user may view the instructions on an output device such as, but not limited to, a display monitor whereby miter cut settings, installation instructions, material and cost estimates, skill level ratings, time line estimates, and other reports are presented to the user to either print, display, transmit or store in an electronic media such as but not limited to a USB media stick, Compact Flash Card or Smart Media, CDROM disk, floppy disk, or DVD disk, BlueRay disk, or any other data storage media.

FIG. 1b illustrates an alternate process flow of the present invention for adding custom decorative trim to a wall or ceiling for a given room. In Step 1 of FIG. 1b, Select Room 115 allows the user to select one or more rooms from a given list of pre-defined rooms. In Step 2 of FIG. 1b, Configure Walls 116 allows user to add or delete multiple walls, define wall width and length for each added wall, define angles between adjacent walls, define structural on each added wall, and define trim objects on each added wall. In Step 3 of FIG. 1b, Select Molding 117 allows user to select or define a molding based on type, vendor, cost, style, and other related molding factors. Step 4 of FIG. 1b is identical to Step 3 of FIG. 1a as previously presented.

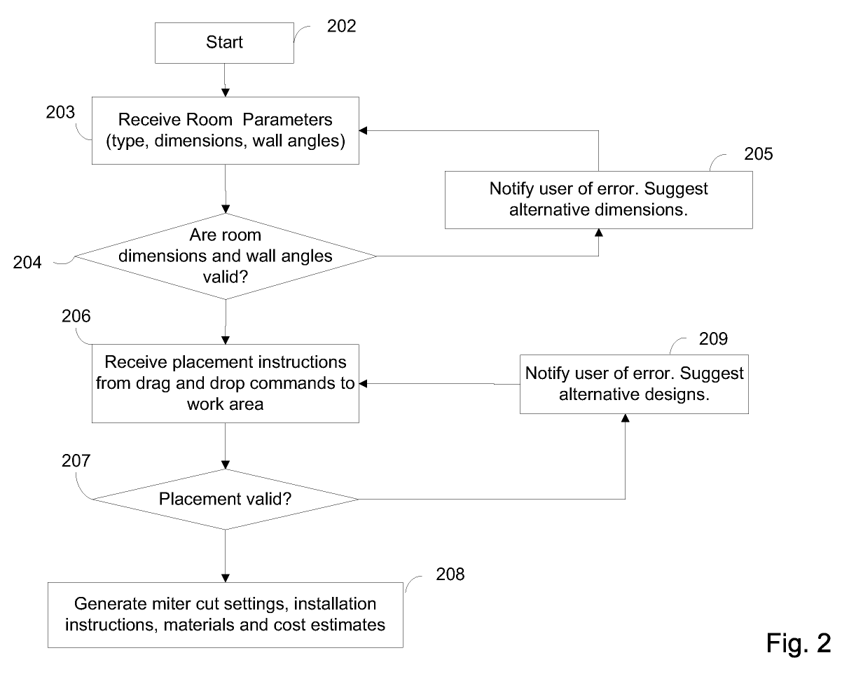

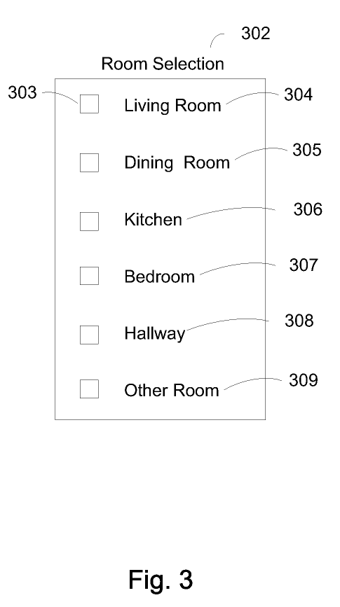

In a preferred embodiment, FIG. 2 illustrates a flow of the invention's application implemented on a computer system (system) for adding custom decorative trim to a wall or ceiling. The system Starts 202 by receiving input from a user either from a keyboard, touch screen, Internet, storage medium, or other electronic means, in which the user selects rooms and enters the dimensions of each room. At the Receive Room Parameters 203 step, the rooms are selected by the user from a predetermined list provided by the system under the Room Selection 302 as shown in FIG. 3.

Referring to FIG. 3, the list of rooms includes, but is not limited to, the Living Room 304, the Dining Room 305, the Kitchen 306, the Bedroom 307, the Hallway 308, and Other Rooms 309. Other Rooms 309 include but are not limited to, dens, family rooms, bathrooms, play rooms, guest rooms, dining rooms, nursery rooms, craft rooms, basements, sunrooms, and any other rooms that the user defines and outside structures. Other room parameters may include but are not limited to room dimensions and wall angles. Examples of room dimensions for a given room may include the width and height of each wall associated with the room. An example of a wall angle can include the angle between adjacent walls.

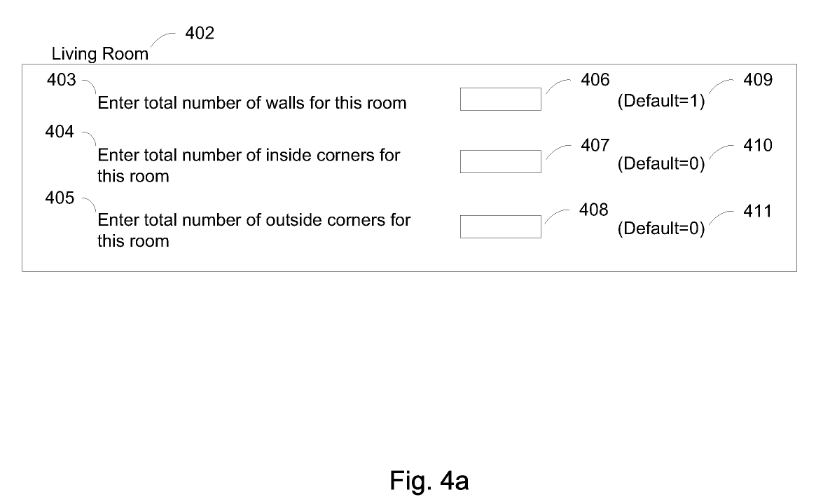

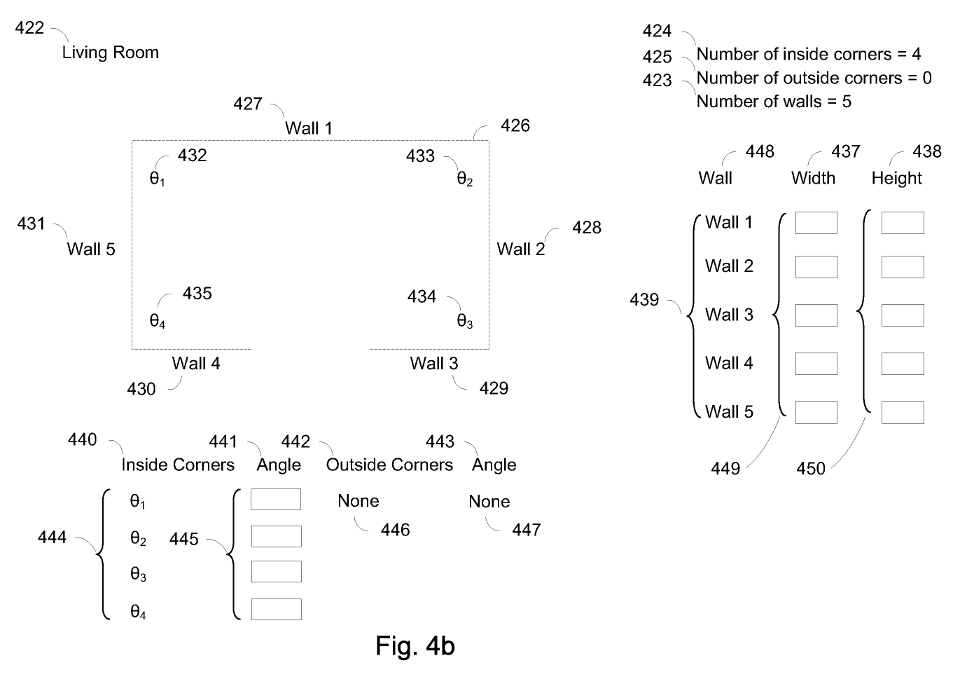

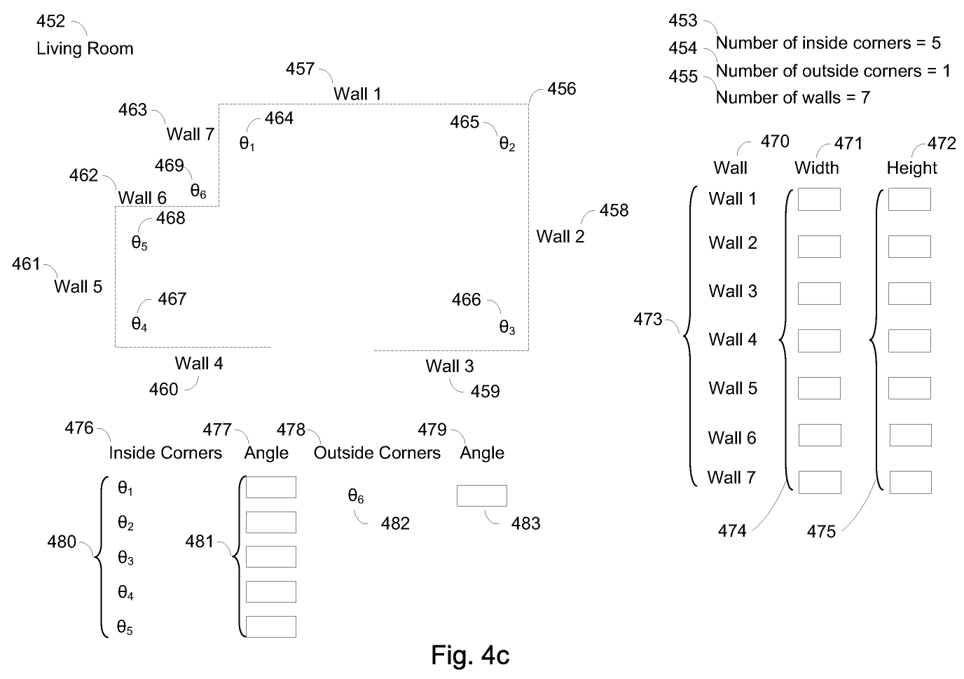

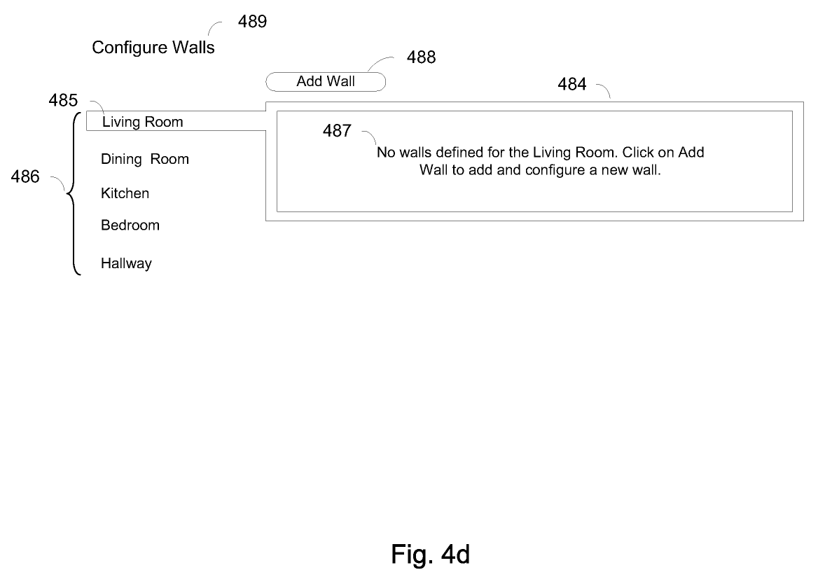

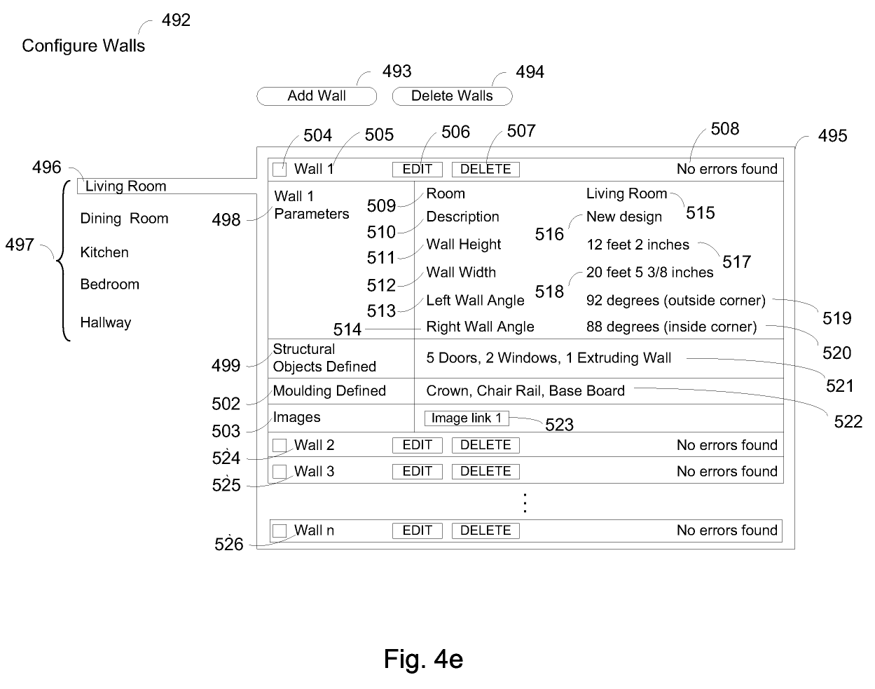

Referring again to FIG. 2, the system verifies that room dimensions and wall angles are valid based on the information received by the system at Step 204. If the room dimensions are not valid, as defined by a set of pre-defined room and wall rules or logic, at step 205, the system notifies the user of the errors by prompting the user with an error message and suggesting alternative dimensions that the user may input into a room setup screen as illustrated in FIG. 4b, the Living Room 422. An example of an invalid room dimension would be where the room dimensions and wall angles when entered into the system are negative numbers, non-numbers, or numbers greater than a pre-determined room or wall angle value. If the room dimensions are valid, the system proceeds to receive placement instructions 206 from drag and drop command of decorative trim onto a work area. The work area is the room chosen by a user in which the user is entering the chosen room's data, for example the Living Room 422 in FIG. 4b. Continuing with FIG. 2, in step 207 the system verifies that the decorative trim placement are valid based on the placement information received by the system. Verification of the placement can be determined by checking the overlap between a pre-defined trim area and the decorative trim object. A pre-defined trim area is either a designated trim area or a non-trim area. An example of an invalid user placement of the decorative trim is where the placement of the decorative trim overlaps a non-trim area. If the placement of decorative trim is not valid, at step 209 the system notifies the user of the errors by prompting the user with an error message and suggests alternative placements. If the decorative trim placements are valid, at step 208 the system generates simulated images of the room in accordance to decorative trim placement parameters, detailed miter cut settings, detailed installation instruction, and material & cost estimates reports, in addition to many other reports, including but not limited to skill rating summary, project timeline summary, and product information reports.

Illustrated in FIGS. 3, the system provides the user a list of rooms under the Room Selection 302 step. Rooms may be selected by clicking on one or more selection boxes 303 that are adjacent to each of the rooms. Examples of selectable rooms include the Living Room 304, Dining Room 305, Kitchen 306, Bedroom 307, Hallway 308, and Other Room 309. Other Room 309 may include any type of room regardless of size or type. Examples of Other Room 309 rooms include, but are not limited to, dens, family rooms, bathrooms, play rooms, guest rooms, dining rooms, nursery rooms, craft rooms, basement, sunroom, and any other rooms that the user defines, and exterior of the home or any other outdoor structure where decorative trim may be added. The system is capable of accepting multiple rooms as defined by the user. If Other Room 309 is selected as a room, the system prompts the user to enter the name of the room. Moreover, there are no limits on the number of Other Room 309 rooms the system will accept as defined by the user. The room information is stored for future retrieval and use by the system when the user sets up each room and when the system creates an output that includes each room. An example of a web based code for implementing the Room Selection 302 step is shown in Table 1.0 below.

TABLE 1.0
Exemplary web base code for selecting rooms

<table width=“100%” border=“0” align=“center” cellpadding=“3”
cellspacing=“0”>
<tr>
<td width=“13%” class=“style14”><span class=“style24”>
<label>
<input id=“R24” name=“R24” type=“checkbox” value=“Living Room”
<?php if (isset($_SESSION[‘R24’])) {echo ‘Checked disabled’;} else
{echo ”;}?>/>
Living Room </label>
</span>
</td>
<td width=“27%” class=“style14”><span class=“style24”>
<?php if (isset($_SESSION[‘R24’])) {echo ‘<span
class=“help”><a href=“
roominput.php?clear=R24”> [remove]</a></span>’;}?>
</span></td>
<td width=“16%” class=“style14”><label>
<input id=“R8” type=“checkbox” name=“R8”
value=“Bedroom (Master)” <?php
if (isset($_SESSION[‘R8’])) {echo ‘Checked disabled’;} else
{echo ”;}?>/>
Bedroom (Master) </label></td>
<td width=“26%” class=“style14”><?php if
(isset($_SESSION[‘R8’])) {echo
‘<span class=“help”><a href=“ roominput.php?clear=R8”>
[remove]</a></span>’;}?></td>
<td width=“12%” class=“style14”><label>
<input id=“R1” type=“checkbox” name=“R1” value=“Bathroom
1” <?php if
(isset($_SESSION[‘R1’])) {echo ‘Checked disabled’;} else {echo ”;}?>/>
Bathroom 1 </label></td>
<td width=“6%” class=“style14”><?php if (isset($_SESSION[‘R1’]))
{echo
‘<span class=“help”><a href=“ roominput.php?clear=R1”>
[remove]</a></span>’;}?></td>
</tr>
</table>

Using a Living Room 402 as an example of the data entry screen for a specific room, FIG. 4a illustrates the wall and corner user input screen for the room selected, here the Living Room 402, as shown in the Room Selection 302 step, in FIG. 3. In the wall and corner user input screen, FIG. 4a, three parameters are defined. The first parameter is Total Number of Walls 403 and is used by the system to determine the room's wall configuration. The user may enter a whole number in the user input box 406. If no number is entered, the system defaults to one (default=1) 409. The second parameter is Total Number of Inside Corners 404 and is used by the system to determine the room's inside corners configuration. The user may enter a whole number in the user input box 407. If no number is entered, the system defaults to zero (default=0) 410. Inside corners are defined as a corner having an angle between two adjacent walls that is greater than 0 degrees and less than 180 degrees. The second parameter is the Total Number of Outside Corners 405 and is used by the system to determine the room's outside corners configuration. The user may enter valid numbers in the user input box 408. If no number is entered, the system defaults to zero (default=0) 411. Outside corners are defined as a corner having an angle between two adjacent walls that is greater than 180 degrees and less than 360 degrees.

Once wall and corner parameters are defined, the system further provides a subsequent user input screen that allows the user to input wall widths and heights, for each wall within a room and the angles for both inside and outside corners associated with each wall. FIG. 4b shows an example of the user input screen of the Living Room 422.

The Living Room 422 has five walls, displayed by a dashed line 426, Wall 1 427, Wall 2 428, Wall 3 429, Wall 4 430 and Wall 5 431. Shown in this user input screen, FIG. 4b, a summary of the number of walls 423, the number of outside corners 425, and the number of inside corners 424 is displayed. Also displayed is a table summarizing the walls 448, and a data entry box for the width 437 of each wall respectively and a data entry box for the height 438 of each wall respectively.

Inside corners shown in FIG. 4b are indicated by a θₓ where θ indicates a corner and x is the corner number. In the example of the Living Room 422 in FIG. 4b, there are four inside corners or wall angles, θ₁ 432, θ₂ 433, θ₃ 434, and θ₄ 435. Also displayed is a table summarizing each inside corner 440 where the inside corner is listed 444. The associated angle 445 is listed under Angle 441.

In FIG. 4b, there are zero outside corners 442 as indicated by the word None 446 and under the Angle 443 None 447 indicates there are not outside angles.

Wall width 437 and height 438 information are entered in the user input boxes 449 and 450 respectively. Each wall width 437 and height 438 corresponds to a wall number input boxes 439. The wall numbers are also represented visually as dashed lines 426 in FIG. 4b as Wall 1 427, Wall 2 428, Wall 3 429, Wall 4 430, and Wall 5 435. Wall width and height may be entered in either feet, inches, meters, centimeters or a combination thereof.

Inside Corners 441 and Outside Corners 442 are entered in a similar fashion as described above. In the Living Room 422 example, Inside Corners 440 is defined to have four inside corners and zero outside corners. Inside Corners 440 is represented by θ₁, θ₂, θ₃, and θ₄ 444 and have a corresponding user input box 445 in which Angle 441 data is entered. Each inside corner or wall angle are also represented visually as corners θ₁ 432, θ₂ 433, θ₃ 434, and θ₄ 435. Angles may be entered in either degrees or radians or a combination thereof. In the Living Room 422 example, Outside Corners 425 is defined to have zero outside corners, and subsequently have Outside Corners 442 and Angle 443 set to None 446 and 447 respectively.

Referring to FIG. 4c, FIG. 4c demonstrates a Living Room 452 that has at least one outside corner. In this example, Living Room 452 has seven walls 473 listed under Wall 470, five inside corners 476 and one outside corner 478. Wall width 471 and height 472 information are entered in the user input boxes 474 and 475 respectively. Each wall width 471 and height 472 corresponds to a wall number 473. The wall numbers are also represented visually as dashed lines 456 as Wall 1 457, Wall 2 458, Wall 3 459, Wall 4 460, Wall 5 461, Wall 6 462, and Wall 7 463. Wall width 471 and wall height 472 may be entered in either feet, inches, meters, centimeters or a combination thereof. Wall width 471 and height 472 information are entered in the user input boxes 474 and 475 respectively.

Inside Corners 476 and Outside Corners 478 are entered in a similar fashion as described above. In the Living Room 452 example, Inside Corners 476 is defined to have five inside corners and one outside corner. Inside Corners 476 is represented by θ₁, θ₂, θ₃, θ₄ and θ₅ 480 and have a corresponding user input box 481 in which Angle 477 data is entered. Each inside corner is also represented visually as corners θ₁ 464, θ₂ 465, θ₃ 466, θ₄ 467 and θ₅ 468. In the Living Room 452 example, Outside Corners 478 is defined to have one outside corner 469, and subsequently have Outside Corners 478 and Angle 479 as indicated by the outside corner listing 482 with the outside corner angle 469 entered in user input box 488. Angles may be entered in either degrees or radians or a combination thereof.

Conversion algorithms for angles and dimensions are supported by the system. Examples include, but are not limited to, conversion from degrees to radians, radians to degrees, feet to meters, and meters to feet.

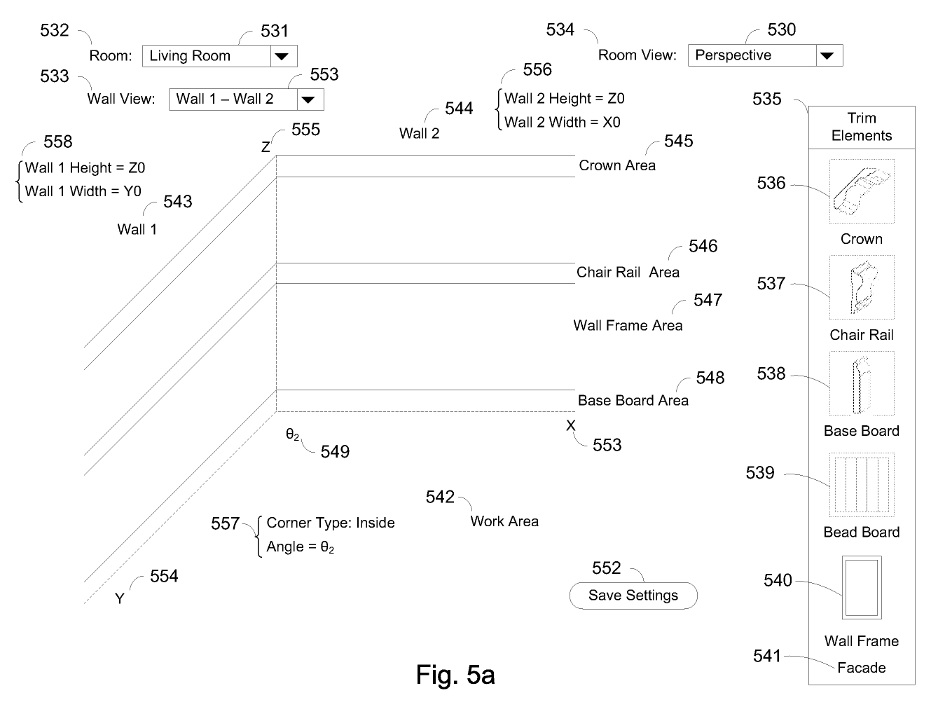

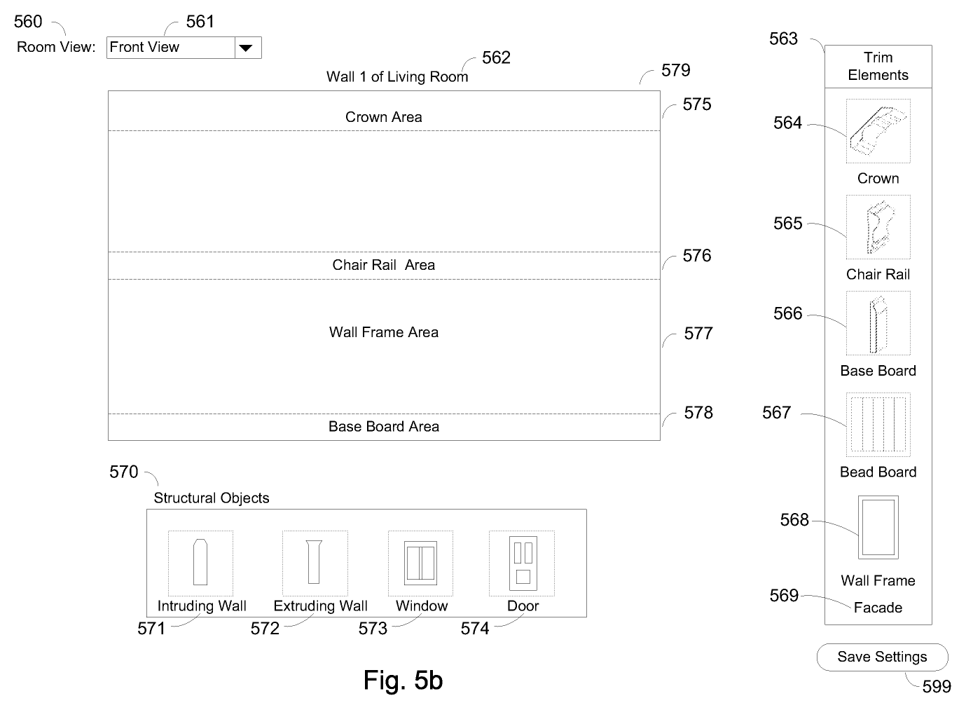

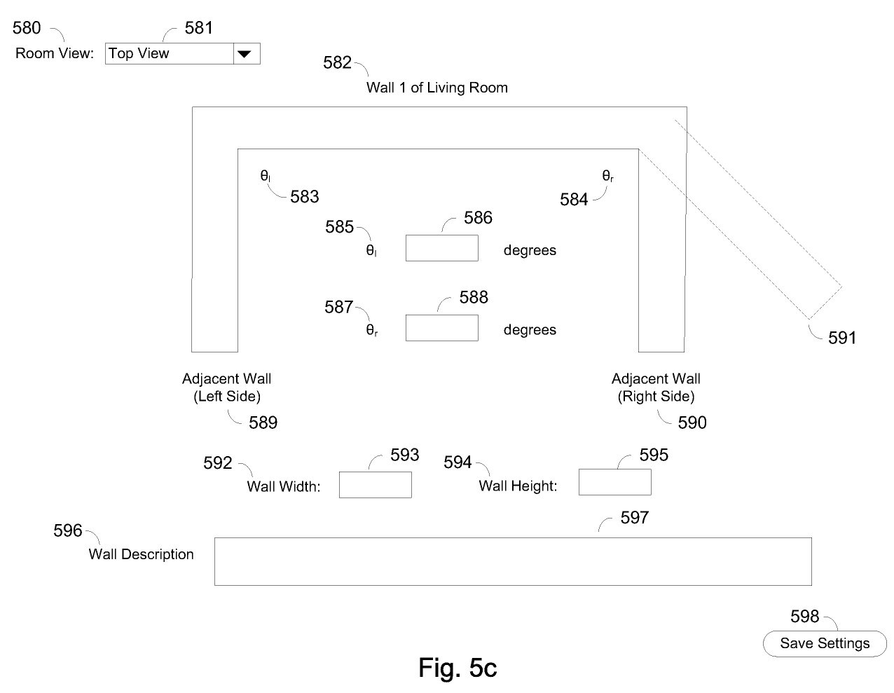

FIG. 4d illustrates an alternate implementation of adding and defining walls and corner data for a single room or for multiple rooms. In the Configure Walls 489 step shown in FIG. 4d, the system may receive new walls for a set of selected rooms 486 previously defined in the Room Selection 302 step of FIG. 3. In this example, the wall configuration parameters for Living Room 485 are displayed in the configure wall display area 484. When the system has no walls defined for a given room, a warning message 487 is generated notifying the user that no walls are defined. The message 487 further outputs a message “Click on Add Wall to add and configure a new wall” indicating appropriate actions to take to add and define a new wall. New walls can be added when the system receives appropriate input to add a new wall. This task is accomplished when the Add Wall 493 button is selected. When a new wall is added, the system displays an interactive user input screen as depicted in FIG. 5a, FIG. 5b, and FIG. 5c. Details and the description of FIG. 5a, FIG. 5b, and FIG. 5c is presented later.

FIG. 4e illustrates the same Configuration Walls 492 step of FIG. 4d with newly added walls, Wall 1 505, Wall 2 524, Wall 3 525, . . . , Wall n 526, defined for the Living Room 496 and displayed in area 495. A list of rooms 497 available to add and configure walls may be selected from this list of rooms. Note, the list of rooms 497 are generated from the room selected in the Room Selection Step shown in FIG. 3. New walls are added when the system receives the appropriate input to add a new wall which is initiated when the Add Wall 493 button is selected. Conversely, walls may be deleted when the system receives the appropriate input to delete a wall. This task is accomplished by selecting or checking the wall selection box 504 followed by depressing the Delete Walls 494 button. When the selection box 504 is selected, a check mark appears in the selection box next to a wall such as Wall 1 505. The system can receive multiple selection boxes which enables the system to delete multiple selected walls such as Wall 2 524, Wall 3 525, . . . , Wall n 526 when the Delete Walls 494 button is selected. Alternatively, walls may be deleted a single wall at a time when the system receives the appropriate input to delete a single wall. A single wall can be deleted when the DELETE button 507 is selected for a given wall such as Wall 1 505. The Configure Walls 492 step also provides wall related information for all new walls received by the system. For example, for Wall 1 505, Wall 1 Parameters 498 section contains the wall related information such as Room 509 in which the wall is located, Description 510 of wall, Wall Height 511, Wall Width 512, Left Wall Angle 513, and Right Wall Angle 514. Examples of settings or values for Wall 1 Parameters 498 are Living Room 515, New design, 516, 12 feet 2 inches 517, 20 feet 5⅜ inches 518, 92 degrees (outside corner) 519, and 88 degrees (inside corner) 520. Other wall information displayed by the system as received by the system are Structural Objects Defined 499, Molding Defined 502, and Images 503 whereby exemplary setting or values are 5 Doors, 2 Windows, 1 Extruding Wall 521, Crown, Chair Rail, Base Board 522, and Image link 1 523, respectively. There is no limit on the number of walls that can be added to a given room. For example, in FIG. 4e, a total of “n” rooms are shown in the Configure Walls 492 step where “n” is the total numbers of walls added as indicated by Wall n 526. Information displayed in the Configuration Walls 492 step can be minimized or maximized depending on the mode selected. For example, Wall 1 505 is shown to be maximized and wall 1505 parameters are displayed, while Wall 2 524, Wall 3 525, . . . Wall n 526 are shown to be minimized and no parameters are displayed. The system provides features which allows toggling between minimizing and maximizing the wall information window by selecting Wall 1 505, Wall 2 524, Wall 3 525, . . . , or Wall n 526. The system also provides editing capabilities of wall information for each wall. For example, EDIT 506 button, when selected, allows the system to receive new or modified wall information for Wall 1 505. In edit mode, the system displays an interactive user input screen as depicted in FIG. 5a, FIG. 5b, and FIG. 5c. Details and descriptions of FIG. 5a, FIG. 5b, and FIG. 5c are presented in the next section. Status information 508 is also provided by the system to the user indicating error or warning messages about missing or invalid data entered by the user.

FIG. 5a illustrates an example of a work area 542, in this example the Living Room 531, where the system receives placement information of all drag and drop decorated trim elements 535 into wall areas labeled Wall 1 543 and Wall 2 544. Drag and drop decorated trim elements 535 are comprised of, but not limited to, the Crown 536 molding, Chair Rail 537, Base Board 538, Bead Board 539, Wall Frame 540, and Façade 541. The purpose of the work area is to allow the user to drag and drop pre-defined decorated trim elements 536-541 to decorative trim areas labeled Crown Molding Area 545, Chair Rail Area 546, Wall Frame Area 547, and Base Board Area 548. Note, these decorative trim areas are pre-defined within the system. Each work area is capable of receiving any of the drag and drop decorated trim elements 535.

Referring to FIG. 5a, Room 532 allows the user to select from a drop down box the room to be displayed in the work area 542. The room chosen to be displayed in work area 542 includes, and may include multiple of rooms, such as, but is not limited to, a living room, a dining room, a kitchen, a bedroom, a hallway, a den, a family room, a bathroom, a play room, a guest room, a dining room, a nursery room, a craft room, a basement, a sunroom, or any other room regardless of size or type that the user defines, including any room exterior of the home or any other outdoor structure where weather proof decorative trim may be added. Living Room 531 is shown as the current room displayed in the Work Area 542. Room View 534 allows the user to select from a drop down box the view of the room to be displayed in the work area 542. The choices of room views are, but not limited to, a perspective view, front view, top view, back view, or side view. A perspective view 530 is shown as the current room view 534 of the room displayed in the Work Area 542. Wall View 533 allows the user to select from a drop down box the walls that are to be displayed in the Work Area 542. Walls 1-Wall 2 553 is shown as the current wall view in which Wall 1 543 and Wall 2 544 are displayed in work area 542. Wall 1's Height and Width 558 and Wall 2's Height and Width 556 dimensions that were previously defined in wall and ceiling dimension input and configuration screen shown in FIGS. 4b-4c for a selected room are automatically displayed in Work Area 542. Wall 1 Height & Width 558 dimensions and Wall 2 Height & Width 556 dimensions are shown in the display area, Work Area 542, for Living Room 531. Axes X 553, Y 554, and Z 555 represent the three-dimensional perspective room view whereby X 553 represents the width of Wall 2 544, Y 554 represents the width of Wall 1 543, and Z 555 represents the heights of Wall 1 543 and Wall 2 544. Wall 1 543 and Wall 2 544 have equal height dimension Z 555. Height dimensions may vary between walls as specified by the user during the dimension input.

Referring to FIG. 5a, θ₂549 represents the wall angle between Wall 1 543 and Wall 2 544 and is displayed in the Work Area 542. Corner Type and Angle 557 are also displayed on Work Area 542 and indicates the type of corner and the angle dimensions previously defined in wall and ceiling dimension input and configuration screen shown in FIGS. 4a-4e. FIG. 5a, displays an example of the Corner Type which is an Inside corner while the Angle between walls 1 and 2 is θ₂ 549. In other embodiments, the corner type may be an Outside corner or any combination thereof. Selection of decorative trim elements, structural objects and placement thereof can be saved to the system by selecting the Save Settings 552 button.

FIG. 5b illustrates an alternate view of the Living Room 531 shown in FIG. 5a. In FIG. 5b, Room View 560 is set to the Front View 561 which depicts the front facing view of a single wall in work area 579. In this example, Wall 1 of Living room 562 is illustrated. The choices of room views are, but not limited to, a perspective view, front view, top view, back view, or side view. The system receives placement information of all drag and drop decorated trim elements 563 into work area 579. In FIG. 5b, drag and drop decorated trim elements 563 are comprised of, but not limited to, Crown 564 molding, Chair Rail 565, Base Board 566, Bead Board 567, Wall Frame 568, and Façade 569. The purpose of the work area is to allow the user to drag and drop pre-defined decorated trim elements 564-569 to decorative trim areas labeled Crown Area 575, Chair Rail Area 576, Wall Frame Area 577, and Base Board Area 578. Note, these decorative trim areas are pre-defined within the system. Each work area is capable of receiving any of the drag and drop decorated trim elements 563. The system also receives placement information of all drag and drop structural objects 570 into work area 579. Referring to FIG. 5b, drag and drop structural objects 570 include, but not limited to, an Intruding Wall 571, Extruding Wall 572, Window 573, and Door 574. When place on the work area 579, the structural objects 570 serve as representation of physical room objects that are used in combination with decorative trim elements 563 to determine compound miter saw cut settings for all overlapping areas. Each structural object can have one or more angles associated it. A group of angles associated with each structural object is referred to as “wall object angles”. For example, a structural object that is shaped as a rectangle, as viewed from the top, has four wall object angles (i.e., four corners of the rectangle) associated with that object, while a structural object that is shaped like a triangle, as viewed from the top, has three wall object angles (i.e., three angles of the triangle) associated with this object. Multiple miter cut angle settings can be calculated by the system for each structural object which overlaps each decorative element. For example, the structural object Extruding Wall 572 may be placed anywhere on the work area 579 and Crown 564 molding may also be placed on the work area 579. Any overlap between the Extruding Wall 572 and Crown 564 molding are used, in part, to determine miter saw cut settings for the one or more wall object angles associated with the Extruding Wall 572. If the Extruding Wall 572 is defined as a rectangle, the number of wall object angles is four. Selection of decorative trim elements, structural objects and placement thereof can be saved to the system by selecting the Save Settings 599 button.

In yet another alternate view of the Living Room 531 shown in FIG. 5a, a Top View 581 perspective of the living room is illustrated in FIG. 5c. Referring to FIG. 5c, Room View 580 is set to the Top View 581 which depicts three walls as view from above. The three walls may comprise an Adjacent Wall (Left Side) 589, a front facing wall which is Wall 1 of Living Room 582, and an Adjacent Wall (Right Side) 590. Wall angle θ₁ (583, 585) represent the angle between Adjacent Wall (Left Side) 589 and Wall 1 of Living Room 582. Wall angle θ₂ (584, 587) represent the angle between Adjacent Wall (Right Side) 589 and Wall 1 of Living Room 582. Wall angle θ₁ (583, 585) and θ₂ (584, 587) have units that are represented in degrees. However, other units may used by the system such as radians. The system can receive various wall angle settings for θ₁ (583, 585) and θ₂ (584, 587) from user input boxes 586 and 588, respectively. A visual representation of wall angle settings for θ₁ (583, 585) and θ₂ (584, 587) are correspondingly displayed for each wall setting received by the system. Wall 591 illustrates a visual representation of a θ₂ (584) for a setting that is received by the system and is greater than 90 degrees but less than 180 degrees. In another embodiment, the system can receive various wall angle settings for θ₁ (583, 585) and θ₂ (584, 587), by rotating Adjacent Wall (Left Side) 589 or Adjacent Wall (Right Side) 590) using the mouse as a means to drag the wall to a final angle position. Wall 591 in FIG. 5c can be dragged by the mouse to the final wall angle position by point, click-and-hold, and drag methods. When the system receives a wall angle setting by these methods, the final wall angle position received by the system is also updated in the corresponding input boxes 586 and 588. Wall angle settings for θ₁ (583, 585) and θ₂ (584, 587) can take on values between 0 degrees to 360 degrees. The system can determine whether the wall angle setting, θ₁ (583, 585) or θ₂ (584, 587), is an inside corner or an outside corner based on the final wall angle position. To determine if the final wall angle position is an inside corner, the system checks whether the final wall angle position is greater than 0 but less than 180 degrees. To determine if the final wall angle position is an outside corner, the system checks whether the final wall angle position is greater than 180 but less than 360. The system may receive other settings such as Wall Width 592, Wall Height 594, and Wall Description 596 in input boxes 593, 595, and 597, respectively. Wall Width 592 represents the width of Wall 1 of Living Room 582 which starts at the inside edge portion of Adjacent Wall (Left Side) 589 to the inside edge portion of Adjacent Wall (Right Side) 590. Wall Height 594 represents the wall height of Wall 1 of Living Room 582. Wall Width 592 and Wall Height 594 may be entered in either feet, inches, meters, centimeters or a combination thereof. Wall Description 596 represents a description of Wall 1 of Living Room 582. Wall angles, width, height, description and other settings illustrated in FIG. 5c can be saved to the system by selecting the Save Settings 598 button.

An example of a web based code implementing the wall configuration step shown in FIGS. 5a, 5b, and 5c is shown in Table 2.0 below.

TABLE 2.0
Exemplary web base code for the wall configuration step

ObjectHandler(objectType, object_mc_name, indexNum, x_home,
y_home, left, top, right, stagebottom)
{
_root[objectType+indexNum]._x = x_home;
_root[objectType+indexNum]._y = y_home;
_root[objectType+indexNum].onPress = function( )
{
hideAllicons( );
startDrag(this, false, left, top, right, stagebottom);//left,top,right,bottom
if (objectType==“crown”)
{
if (_root[“bucrown1”]._x != undefined)
{
_root[“bucrown1”].swapDepths(0);
_root[“bucrown1”].removeMovieClip( );
getTrimObjTotals( );
}}
if (objectType==“bucrown”)
{
if (_root[“crown1”]._x != undefined)
{
_root[“crown1”].swapDepths(0);
_root[“crown1”].removeMovieClip( );
getTrimObjTotals( );
}}}
{if (objectType==“crown”) {showChairrailCaps( );}
}
_root[objectType+indexNum].onRollOver = function( )
{
thisobject = this;
object_mc = object_mc_name;
showAllicons(object_mc);
}
_root[“delObject_mcx”].onPress = function( )
{
thisobject.swapDepths(0);
thisobject.removeMovieClip( );
if (objectType==“crown” || objectType==“chairrail” )
{hideChairrailCaps( );}
hideAllicons( );
getObjTotals( );
getTrimObjTotals( );
}
_root[“scaleUp_mcx”].onPress = function( )
{
scaleUp(thisobject,object_mc);
}
_root[“scaleDown_mcx”].onPress = function( )
{
scaleDown(thisobject,object_mc);
}
_root[objectType+indexNum].onRelease = function( )
{
showAllicons(object_mc);
var ObjectsArea_Overlap:Boolean = this.hitTest(trashcan_mc);
if (ObjectsArea_Overlap == true)
{
this.swapDepths(0);
this.removeMovieClip( );
hideAllicons( );
getObjTotals( );
getTrimObjTotals( );
}
if ((this.hitTest(WorkArea_roomobj_scroller_top) == true) ||
(this.hitTest(panel_mc) == true))
{
this._y = y_home;}
if (object_mc_name==“extwall_mc”)
{
getTotalExtHdr = getObjcount(“exthdrwall”, 10);
for (hov=1; hov <= getTotalExtHdr; hov++)
{
if ((this.hitTest(_root[“exthdrwall”+hov]) == true))
{
exthdrwall_center = _root[“exthdrwall”+hov]._x +
0.5*(_root[“exthdrwall”+hov]._width);
capwidth = 20;
if (this._x < exthdrwall_center)
{
this._x = _root[“exthdrwall”+hov]._x − this._width + capwidth;
}
if (this._x > exthdrwall_center)
{
this._x = _root[“exthdrwall”+hov]._x +
_root[“exthdrwall”+hov]._width −
capwidth;
}}}}
stopDrag( );}

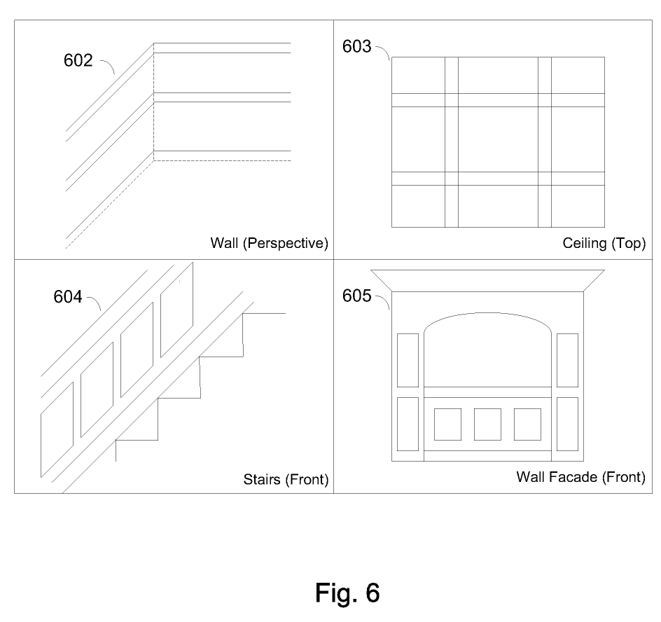

The system supports various molding configurations for areas such as Wall (Perspective) 602, Ceiling (Top) 603, Stairs (Front) 604, and Wall Façade (Front) 605 as illustrated in FIG. 6. These configurations are not inclusive and other optional designs will be apparent to one skilled in the art. Wall (Perspective) 602 is allows the viewing and configuration of multiple walls. Ceiling (Top) 603 allows the viewing and configuration of the ceiling as viewed from below. Stairs (Front) 604 allows the viewing and configuration of a stairs. The Wall Façade (Front) 605 view allows viewing and configuration of the wall façade containing pre-defined receiving areas for decorative trim elements.

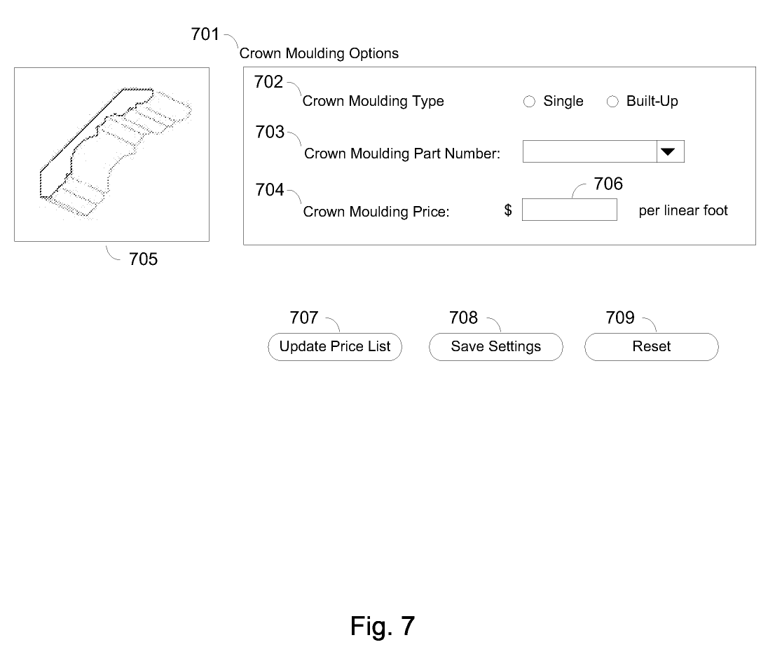

FIG. 7 illustrates the Crown Molding Options 701 whereby the system can receive Crown molding information such as Crown Molding Type 702, Crown Molding Part Number 703, and the Crown Molding Price 704. The Crown Molding Price 704 can be entered automatically by the system via data acquired from a database for a given Crown Molding Part Number 703, or manually entered into the Crown Molding Price Box 706. A list of Crown Molding Part Numbers 703 can be stored in the system and retrieved from a local computer or stored and retrieved from a computer connected to the Internet at home improvement web sites. The dollars per linear foot associated with each Crown Molding Part Numbers 703 are stored in the system along with the three-dimensional drawing or may be overwritten by manual entry. Based on the Crown Molding Part Number 703 selected, a three-dimensional view of the crown molding of the selected Crown Molding Part Numbers 703 is displayed in Display Area 705. The system allows the user to update pricing information in real-time by selecting the Update Price List 707 button. A Save Settings 708 button allows the user to store entries based on the user's selection and data entry. A Reset 709 button allows the user to reset all crown molding parameters, including the Crown Molding Type 702, the Crown Molding Part Number 703, and the Crown Molding Price 704, back to default values such as unselected or empty values.

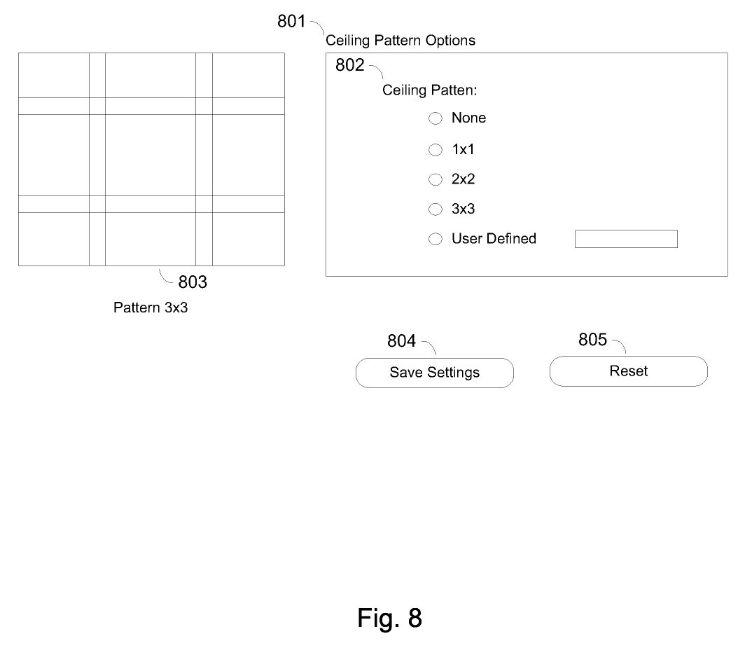

FIG. 8 illustrates the Ceiling Pattern Options 801 screen for defining the ceiling pattern areas for decorative trim placement. Ceiling patterns are an arrangement or array of overlapping non-structural objects generally forming a tick-tack-toe like pattern that are rectangular in shape but may take other forms or patterns that are non-rectangular in shape such as diamonds, triangles, or other shapes. Ceiling Patterns 802 may be of any arrangement ranging from none, to a 1×1, a 2×2, a 3×3, or any user defined arrangement. Displayed in pattern window 803 is a typical arrangement for coffered ceilings of a 3×3 arrangement. However, the system accepts any valid arrangements in determining the areas for decorative trim placement. A Save Settings 804 button allows the user to store entries based on the user's selection. A Reset 805 button allows the user to reset all Ceiling Pattern Options parameters to default values.

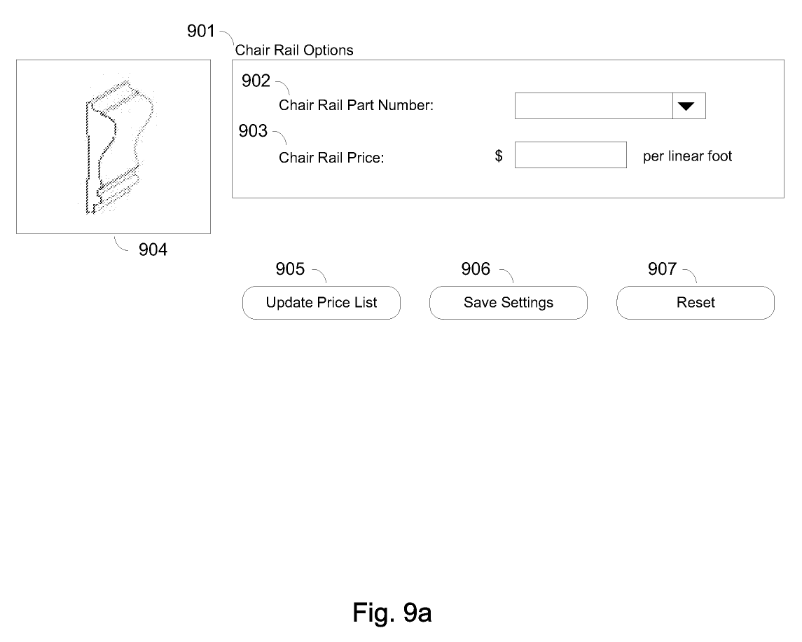

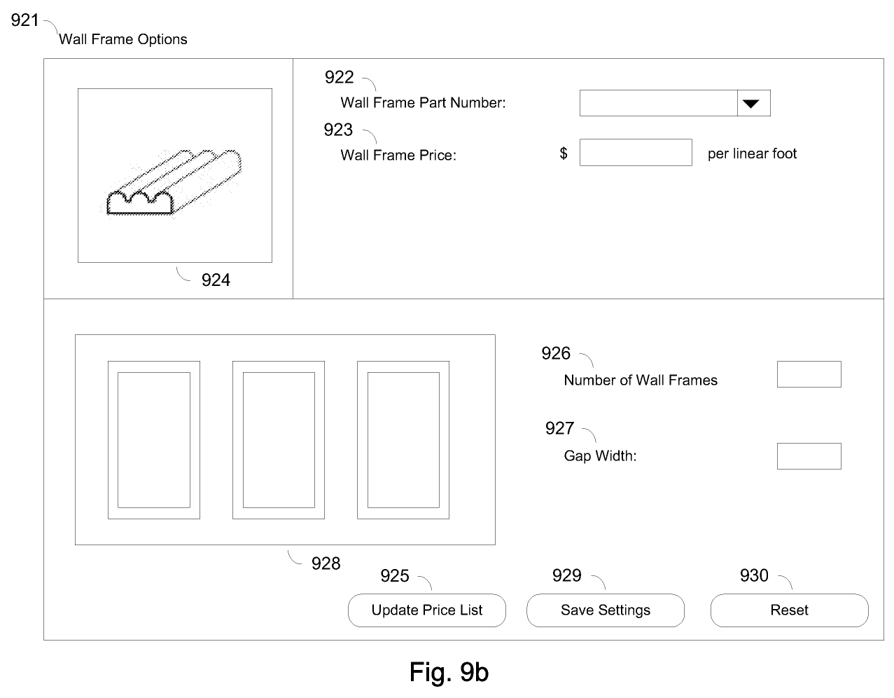

FIG. 9a illustrates chair rail parameters whereby the system can receive configuration settings for the Chair Rail Options 901. For the Chair Rail Options 901, the Chair Rail Price 903 may be either automatically entered based on the Chair Rail Part Number 902, or manually entered based on user input. Based on the Chair Rail Part Number selected 902, a three-dimensional view of the chair rail of the selected part number is displayed 904. The system allows the user to update pricing information in real-time by selecting the Update Price List button 905. A Save Settings 906 button allows the user to store entries based on the user's selection. A Reset 907 button allows the user to reset all chair rail parameters to default values.

FIG. 9b illustrates wall frame parameters whereby the system can receive configuration settings for the Wall Frame Options 921. For the Wall Frame Options 921, the Wall Frame Price 923 may be either automatically entered based on the Wall Frame Part Number 921, or manually entered based on user input. Based on the Wall Frame Part Number selected 922, a three-dimensional view of the wall frame of the selected part number is displayed 924. The system allows the user to update pricing information in real-time by selecting the Update Price List 925 button. A Save Settings 929 button allows the user to store entries based on the user's selection. A Reset button 930 allows the user to reset all wall frame parameters to default values.

In addition to specifying part and pricing information, the Wall Frame Options 921, accepts user input for defining the Number of Wall Frames 926 for a selected wall. By default, the system automatically calculates the best number of wall frames for a given wall length. If the user attempts to enter a number that is invalid or exceeds the physical length of a given wall, the system will display an error message (not shown) and suggest an alternative number of wall frames. The Gap Width 927 is the horizontal distance of the space between two adjacent wall frames and can be either entered manually through a user input text box or automatically calculated by the system. Based on the number of wall frames 926 and Gap Width 927, a front facing view of the number wall frame is displayed 928.

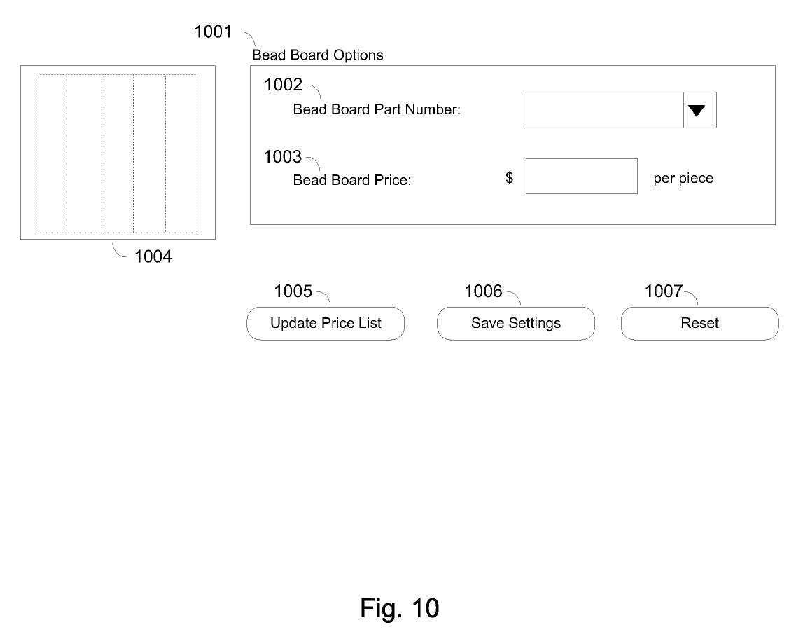

FIG. 10 illustrates bead board parameters whereby the system can receive configuration settings for the Bead Board Options 1001. In the Bead Board Options 1001, the bead board price 1003 may be either automatically entered based on the bead board part number 1002, or manually entered based on user input. Based on the bead board part number selected 1002, a front facing view of the bead board of the selected part number is displayed 1004. The system allows the user to update pricing information in real-time by selecting the Update Price List 1005 button. A Save Settings 1006 button allows the user to store entries based on the user's selection. A Reset 1007 button allows the user to reset all bead board parameters to default values.

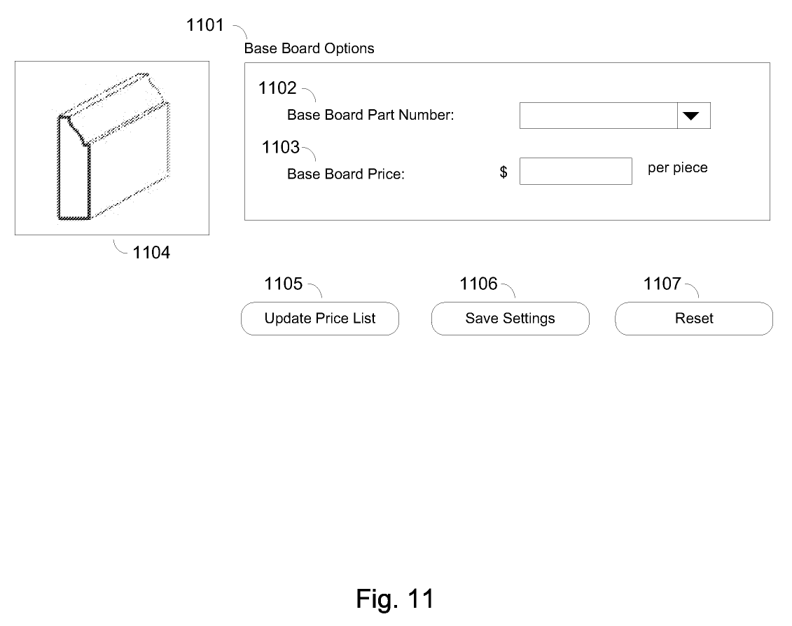

FIG. 11 illustrates base board parameters whereby the system can receive configuration settings for the Base Board Options 1101. In the Base Board Options 1101, the Base Board Price 1103 may be either automatically entered based on the Base Board Part Number 1102, or manually entered based on user input. Based on the Base Board Part Number 1102 selected, a three-dimensional view of the base board of the selected part number is displayed 1104. The system allows the user to update pricing information in real-time by selecting the Update Price List 1105 button. A Save Settings 1106 button allows the user to store entries based on the user's selection. A Reset 1107 button allows the user to reset all base board parameters to default values.

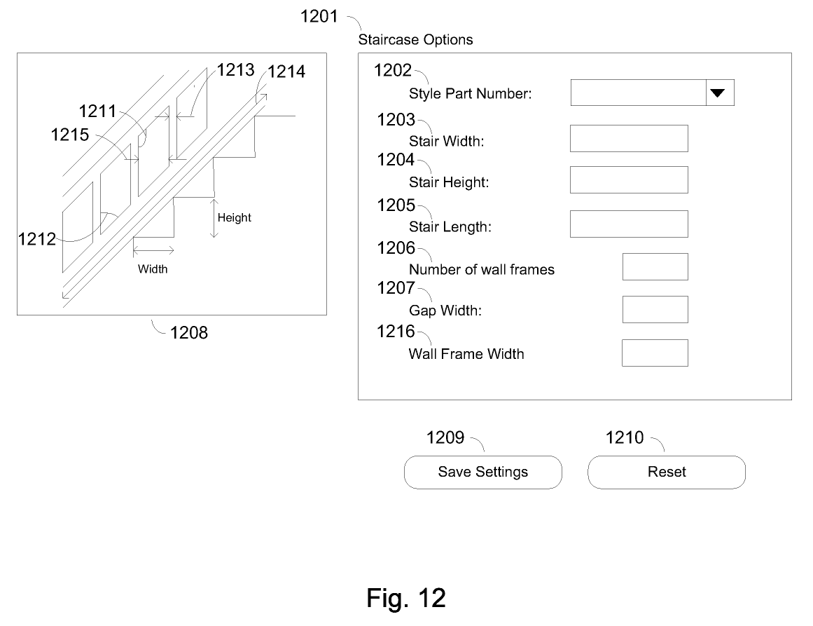

FIG. 12 shows the Staircase Library Options for defining the staircase parameters used for determining the wall frame placement area. In the Staircase Options 1201, the system receives input for a Style Part Number 1202, which contains various staircase styles that may be selected from a drop down box. Based on the inputs received in the Staircase Options 1201, a front view of the staircase is displayed 1208 illustrating the approximate dimensions of the dimensions received or determined by the system. Examples of items displayed in the front view of the staircase 1208 may include, but is not limited to, a width of a single step, a height of a single step, an acute angle 1211, an obtuse angle 1212, a gap width 1213, a stair length spanning all the steps 1214, and a width of a single wall frame 1215. The system may also receive staircase dimensions 1201 used for the wall frame trim placement. To define the staircase dimensions, the system can receive user inputs such as Stair Width 1203, Stair Height 1204, and Stair Length 1205. The system can determine the appropriate stair angle of the flight of stairs based on the Stair Width 1203 and Stair Height 1204 information. The wall frame's acute angle 1212 and obtuse angle 1211 are calculated using Eq. (1) and Eq. (2), respective. Acute angles are angles smaller than a right angle (less than 90°). Obtuse angles are angles larger than a right angle and smaller than a straight line (between 90° and 180°).

Wall-frame angles, θ_{accute} and θ_{obtuse}, for stairs are calculated using:

θ_{accute}=[90−arctan(Hₛₜₐᵢᵣ/Wₛₜₐᵢᵣ)] (1)

wherein, Hₛₜₐᵢᵣ is the stair height 1202, and Wₛₜₐᵢᵣ is the stair width 1201;

θ_{obtuse}=[180−θ_{accute}] (2)

wherein, θ_{accute} is the angle for the acute angle derived in Eq. 1.

Similarly, the system can calculate a staircase wall frame width 1216 from the stair Length 1205, Number of Wall Frames 1206, and Gap Width 1207 between wall frames.

The staircase wall frame width, W_{wall-frame}, is calculated using the equation:

W_{wall-frame}=[W_{length}−(n+1)*W_{gap}]/n (3)

wherein, W_{length} is the Stair Length 1205, W_{gap} is the Gap Width 1207, and n is the Number of Wall Frames 1206. A Save Settings 1209 button allows the user to store entries based on the user's selection. A Reset 1210 button allows the user to reset all stair case options parameters to default values.

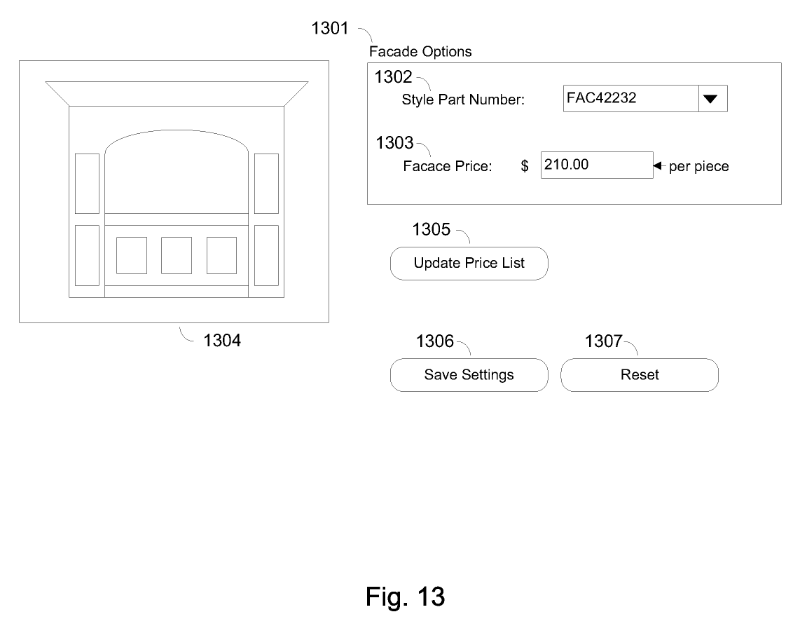

FIG. 13 illustrates the Façade Library Options for defining the facade parameters. In the Facade Options 1301, the user is able to select the facade Style Part Number 1302 for decorative trim placement. Facade styles 1301 come in various configurations and are pre-defined structures that are automatically scaled to the room size defined by the user. Based on the inputs received in the facade Style Part Number 1302, a front view of the facade is displayed 1304 illustrating the a front view of the façade selected from a drop down box next to the Style Part Number 1302. Based on the facade selected in the Style Part Number 1302, a corresponding price is presented by the system in box next to Façade Price 1303. The system determines the appropriate scaling of the façade structure and subsequently determines the necessary materials, cutting requirements, and installation instructions needed to implement the façade. The system allows the user to update pricing information in real-time by selecting the Update Price List 1305 button. A Save Settings 1306 button allows the user to store entries based on the user's selection and data entry. A Reset 1307 button allows the user to reset all Façade Options parameters.

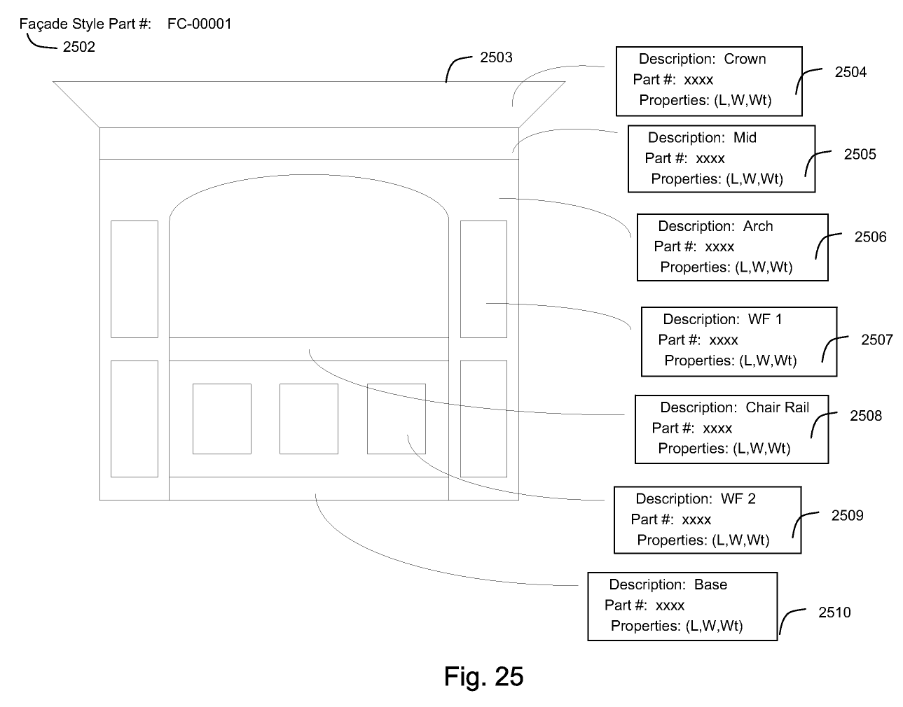

The Façade styles 1301 may be periodically updated with new, customized styles received by the system. The process of defining and adding these structures to the Façade Library is shown in FIG. 25 and is discussed later.

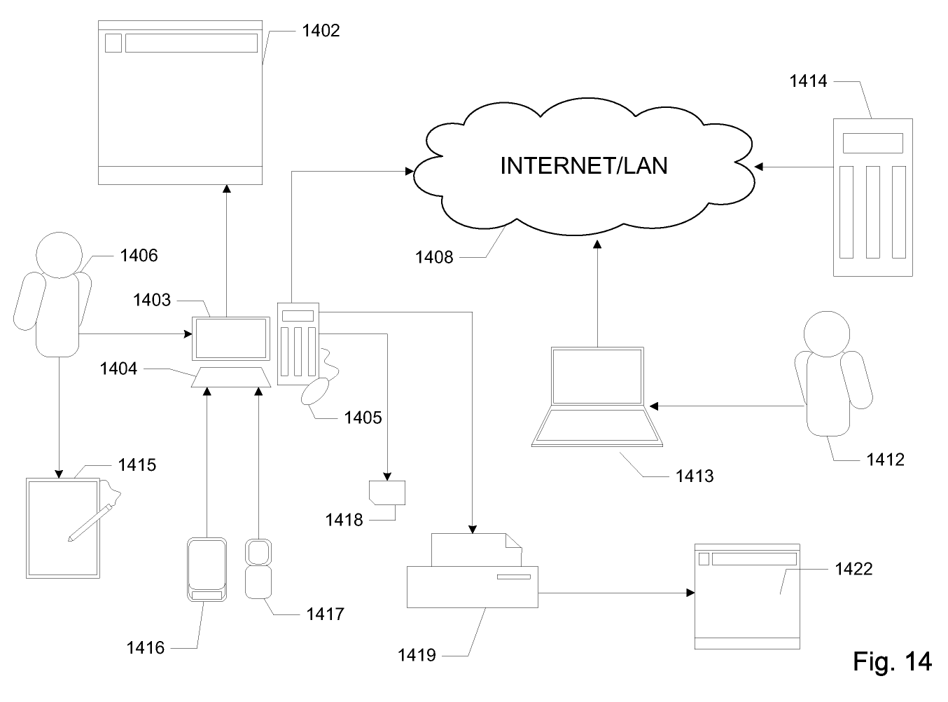

FIG. 14 illustrates a typical implementation of the system and related hardware associated with the system. Software application 1402 resides on a computer having a display monitor 1403, keyboard 1404, and a pointing device 1405. User 1406 can interact with the software application 1402 by following user prompts and instructions provided by the system. The software application can accept data inputs from the User 1406 from the keyboard 1404, the pointing device 1405, or remotely over a network connection 1408 from another User 1412 utilizing a computer 1413 containing a keyboard and pointing device.

In one embodiment of the present invention, software application 1402 may access and utilize a database (not shown) containing product information for each piece of decorative trim such as but not limited to vendor name, part number, code, SKU number, price per unit length, quantity on hand, and style description for determining project costs. The database may reside either on the local computer 1403 or accessed remotely via a network 1408 on a server 1414.

Pre-defined façade structures or other decorative trim files may be uploaded and saved in a database (not shown) to the computer 1403 or server 1414 via a network connection such as a local area network (LAN) or wide area network (WAN) such as the Internet, and shared by multiple users 1406, 1412 of the system. An example of web based code implementing sharing files is shown in Table 3.0 below.

TABLE 3.0
Exemplary web base code for sharing façade structures or decorative
trim files

```
//shared owner files
//get files shared by other users
$sqlcall= “select DISTINCT owner from $db where
shareduser = ‘$memberid’”;
$sqlcall_result = mysql_query($sqlcall) or
die(“Problems loading data to server. Please contact HTC
administrator.”.mysql_error( ));
$num_rows_found= mysql_num_rows($sqlcall_result); //number
of rows found in db
for ($f2b=1; $f2b<=$num_rows_found; $f2b++)
    {
    $rowdata= mysql_fetch_array($sqlcall_result); //fetch data
in array form and put into
    if ($num_rows_found_02b > 0)
        {
        $sharedmember = $rowdata[owner];
        $sharedUserCSV = $sharedmember.‘,’.$sharedUserCSV ;
        $sharedUserString = ‘<option
value=“‘.$file.’?share=‘.$sharedmember.’&shareDesc=
1”>‘.$sharedmember.’
(shared)</option>’.$sharedUserString;
        }//if
    }//for
//shared files
```

Software application 1402 generates miter cut reports, installation instructions, cost and material's list, skill levels, in addition to several other reports, and outputs these reports using a computer 1403 connected to a personal digital assistant 1416, a mobile phone 1417, or a portable memory device 1418 or a printer 1419. An exemplary web based code responsible for generating and implementing the plurality of miter cut instructions in report for is illustrated in Table 4.0.

TABLE 4.0
Exemplary web base code for generating Miter Cut Reports

generate_report($RoomName,$WallNum,$TrimPiece,$TrimType,$ProductCode,
$Quantity,$TrimLength,$Tool,$TrimSideLeftSide,$SideAgainstFenceLeftSide,$Side
ToKeepLeftSide,$BevelAngleLeftSide,$CrossCutAngleLeftSide,$CutImage,$
CutLinkLeftSide,$InstallLink,
$TrimSideRightSide,$SideAgainstFenceRightSide,$SideToKeepRightSide,$Bevel
AngleRightSide,$CrossCutAngleRightSide,$CutLinkRightSide,$Supplier,
$SpringAngle,$Tool)
{
$file = $_SERVER[‘PHP_SELF’];
$RoomNum = $_SESSION[‘RoomNum’];
$PieceLocation = ‘Starting from left most side of wall, this x piece on the wall.’;
$CutImageFinal = ‘Back side<br />
<span class=“resultsRowData”>L<img src=“images/‘.$CutImage.’” alt=“xxx”
width=“103” height=“29”
longdesc=“http://xxx” /> R</span><br />
Front side ’; //formatted version of cut image
if ($TrimType == ‘Crown’) {$TrimName = ‘Crown’;}
if ($TrimType == ‘BuiltUpCrown3Piece’) {$TrimName = ‘Built-Up Crown’;}
if ($TrimType == ‘ChairRail’) {$TrimName = ‘Chairrail’;}
if ($TrimType == ‘BaseBoard’) {$TrimName = ‘Baseboard’;}
$SpringAngleDropDown = ‘<form id=“springangle”>
<select name=“SAmenu” onchange=“MM_jumpMenu(\‘parent\’,this,0)”
class=“dropdownbox”>
<option>‘.$SpringAngle.’&deg</option>
<option value=“”>-------------</option>
<option
value=“‘.$file.’?RoomNum=‘.$RoomNum.’&SpringAngle=38”>38&deg</option>
<option
value=“‘.$file.’?RoomNum=‘.$RoomNum.’&SpringAngle=45”>45&deg</option>
<option
value=“‘.$file.’?RoomNum=‘.$RoomNum.’&SpringAngle=52”>52&deg</option>
<option value=“”>-------------</option>’;
$ToolDropDown = ‘<form id=“tool”>
<select name=“TOOLmenu” onchange=“MM_jumpMenu(\‘parent\’,this,0)”
class=“dropdownbox”>
<option>‘.$Tool.’</option>
<option value=“”>-------------</option>
<option value=“‘.$file.’?RoomNum=‘.$RoomNum.’&Tool=Compound Miter
Saw”>Compound Miter Saw</option>
<option value=“‘.$file.’?RoomNum=‘.$RoomNum.’&Tool=Double Bevel
Compound Miter Saw”>
Double Bevel Compound Miter Saw</option>
<option value=“‘.$file.’?RoomNum=‘.$RoomNum.’&Tool=Box Saw”>Box
Saw</option>
<option value=“”>-------------</option>’;
echo ‘
<table width=“99%” border=“0” cellpadding=“0” cellspacing=“0”>
<tr><td width=“16” height=“21” valign=“bottom”
class=“TableLeftTab”>&nbsp;</td>
<td width=“100%” valign=“bottom” class=“TableCenterTab”>HowToCut&#8482
DETAILED CUT REPORT </td>
<td width=“60” valign=“bottom” class=“TableRightTab”>&nbsp;</td>
</tr><tr>
<td colspan=“3” class=“TableContent”><div align=“center”>
<table width=“100%” border=“0” cellpadding=“0” cellspacing=“0”
class=“resultstable”>
<tr class=“resultstableHeader”>
<td width=“340”><span class=“style1”>‘.$RoomName.’ &gt;‘.$WallNum.’ &gt;
‘.$TrimName.’
</span></td>
<td width=“326”>&nbsp;</td>
<td width=“186”><div align=“center” class=“resultstableHeaderWhite” >Piece:
<a href=“#”
class=“pieceLocation” title=“Piece Location”
onclick=“popuppixwin=window.open(\‘piecelocation.php?Tool=‘.$Tool.’&amp;TrimSide=
Left&amp;LBevelAngle=‘.$BevelAngleLeftSide.’&amp;LMiterAngle=‘.$
CrossCutAngleLeftSide.’&amp;SpringAngle=‘.$SpringAngle.’&amp;SideAgainst
FenceLeftSide=‘.$SideAgainstFenceLeftSide.’&amp;SideToKeepLeftSide=‘.$Side
ToKeepLeftSide.’&amp;RoomName=‘.$RoomName.’&amp;WallNum=‘.$WallNum.-
’&amp;Piece=‘.$TrimPiece.’&amp;VideoClipTitle=Video - Left Trim Side\’,
\‘pixwin\’,\‘toolbar=no,location=no,directories=no,status=no,menubar=no,address
bar=no,scrollbars=no,resizable=no,copyhistory=yes,width=500,height=340\’);
popuppixwin.focus( ); return false;”>‘.$TrimPiece.’</a></div></td></tr>
<tr class=“resultstableHeader”>
<td colspan=“3”><table width=“100%” border=“0” cellpadding=“5”
cellspacing=“0” class=“flashtable”>
<tr bgcolor=“#FFFFFF”>
<td width=“38%” valign=“top”><table width=“100%” border=“0” align=“center”
cellpadding=“0” cellspacing=“2” class=“productinfosection”>
<tr>
<td bgcolor=“#EEEEEE”>Trim Type </td>
<td bgcolor=“#EEEEEE”>‘.$TrimType.’</td>
</tr><tr>
<td bgcolor=“#EEEEEE”><a href=“#” title=“Click for definition”
class=“linkDottedUnderline” onclick=“popuppixwin=window.open
(\‘htc_definitions/springAngle.php\’,
\‘pixwin\’,\‘toolbar=no,location=no,directories=no,status=no,
menubar=no,addressbar=no,scrollbars=no,resizable=no,copyhistory=yes,width=730,
height=500\’);
popuppixwin.focus( ); return false;”>Spring Angle</a></td>
<td bgcolor=“#EEEEEE”>‘.$SpringAngleDropDown.’</td>
</tr><tr><td bgcolor=“#EEEEEE”>Product Code </td>
<td bgcolor=“#EEEEEE”>‘.$ProductCode.’</td>
</tr><tr>
<td bgcolor=“#EEEEEE”>Vendor</td>
<td bgcolor=“#EEEEEE”>‘.$Supplier.’</td></tr><tr>
<td bgcolor=“#EEEEEE”><a href=“#” title=“Click for definition”
class=“linkDottedUnderline” onclick=“popuppixwin=window.open
(\’definitions/CuttingTool.php\’, \‘pixwin\’,\‘toolbar=no,
location=no,directories=no,status=no,menubar=no,addressbar=no,scrollbars=yes,resizable=no,
copyhistory=yes,width=730,height=500\’); popuppixwin.focus( ); return
false;”>Cutting Tool</a></td>
<td bgcolor=“#EEEEEE”>‘.$ToolDropDown.’</td></tr><tr>
<td bgcolor=“#EEEEEE”><span class=“linkDottedUnderline”><a href=“#”
class=“linkDottedUnderline”>Piece location on wall</a></td>
<td bgcolor=“#EEEEEE”>‘.$PieceLocation.’</td>
</tr></table></td></tr></table></td></tr><tr>
<td colspan=“3”><div align=“center”>
<table width=“100%” border=“0” cellpadding=“0” cellspacing=“0”>
<tr bordercolor=“#CCCCCC” bgcolor=“#FFFFFF”>
<td class=“resultsHeader”><a href=“#” title=“Click for definition”
class=“linkDottedUnderline” onclick=“popuppixwin=window.open
(\‘definitions/VideoClip.php\’, \‘pixwin\’,\‘toolbar=no,location=no,
directories=no,status=no,menubar=no,addressbar=no,scrollbars=no,resizable=no,
copyhistory=yes,width=730,height=500\’); popuppixwin.focus( ); return false;”>
Video Clip</a></td>
<td class=“resultsHeader”><a href=“#” title=“Click for definition”
class=“linkDottedUnderline” onclick=“popuppixwin=window.open
(\‘definitions/TrimSide.php\’, \‘pixwin\’,\‘toolbar=no,location=no,
directories=no,status=no,menubar=no,addressbar=no,scrollbars=no,resizable=no,
copyhistory=yes,width=730,height=500\’); popuppixwin.focus( ); return
false;”>Trim Side</a></td>
<td class=“resultsHeader”><a href=“#” onclick=“popuppixwin=window.open
(\‘definitions/SideAgainstFence.php\’, \‘pixwin\’,\‘toolbar=no,
location=no,directories=no,status=no,menubar=no,addressbar=no,scrollbars=no,
resizable=no,copyhistory=yes,width=730,height=500\’); popuppixwin.focus( );
return false;” title=“Click for definition” class=“linkDottedUnderline”>
Side Against Fence</a></td>
<td class=“resultsHeader”><a href=“#” title=“Click for definition”
class=“linkDottedUnderline” onclick=“popuppixwin=window.open
(\‘definitions/SideToKeep.php\’, \‘pixwin\’,\‘toolbar=no,location=no,
directories=no,status=no,menubar=no,addressbar=no,scrollbars=no,resizable=no,
copyhistory=yes,width=730,height=500\’); popuppixwin.focus( ); return
false;”>Side to Keep</a> </td>
<td class=“resultsHeader”><a href=“#” title=“Click for definition”
class=“linkDottedUnderline” onclick=“popuppixwin=window.open
(\‘definitions/MiterAngle.php\’, \‘pixwin\’,\‘toolbar=no,location=no,
directories=no,status=no,menubar=no,addressbar=no,scrollbars=no,resizable=no,
copyhistory=yes,width=730,height=500\’); popuppixwin.focus( );
return false;”>Miter Angle</a> (deg) </a></td>
<td class=“resultsHeader”><a href=“#” title=“Click for definition”
class=“linkDottedUnderline” onclick=“popuppixwin=window.open
(\‘definitions/TiltAngle.php\’, \‘pixwin\’,\‘toolbar=no,location=no,
directories=no,status=no,menubar=no,addressbar=no,scrollbars=no,resizable=no,
copyhistory=yes,width=730,height=500\’); popuppixwin.focus( );
return false;”>Tilt Angle</a> (deg)</td>
<td class=“resultsHeader”><a href=“#” title=“Click for definition”
class=“linkDottedUnderline” onclick=“popuppixwin=window.open
(\‘definitions/CutProfiles.php\’, \‘pixwin\’,\‘toolbar=no,location=no,
directories=no,status=no,menubar=no,addressbar=no,scrollbars=no,resizable=no,
copyhistory=yes,width=730,height=500\’); popuppixwin.focus( );
return false;”>Cut Profiles</a><br />
(Top View)</td></tr>
<tr bordercolor=“#CCCCCC” bgcolor=“#FFFFFF”>
<td class=“resultsLeftSide”><p align=“center”><a href=“#”
title=“Video - Left Trim Side” onclick=“popuppixwin=window.open
(\‘videoclip.php?Tool=‘.$Tool.’&amp;TrimSide=Left&amp;
LBevelAngle=‘.$BevelAngleLeftSide.’&amp;LMiterAngle=‘.$CrossCutAngleLeft
Side.’
&amp;SpringAngle=‘.$SpringAngle.’&amp;SideAgainstFenceLeftSide=‘.
$SideAgainstFenceLeftSide.’&amp;SideToKeepLeftSide=‘.$SideToKeepLeftSide.-
’&amp;
RoomName=‘.$RoomName.’&amp;WallNum=‘.$WallNum.’&amp;Piece=‘.$Trim
Piece.’&amp;
VideoClipTitle=Video - Left Trim Side\’, \‘pixwin\’,\‘toolbar=no,location=no,
directories=no,status=no,menubar=no,addressbar=no,scrollbars=no,resizable=no,
copyhistory=yes,width=500,height=340\’); popuppixwin.focus( ); return false;”>
<img src=“images/videoclipartL.gif” alt=“ Video” width=“28” height=“32” border=
“0”/>
</a></p></td>
<td class=“resultsLeftSide”><p align=“center”>‘.$TrimSideLeftSide.’</p></td>
<td class=“resultsLeftSide”><p
align=“center”>‘.$SideAgainstFenceLeftSide.’</p></td>
<td class=“resultsLeftSide”><p
align=“center”>‘.$SideToKeepLeftSide.’</p></td>
<td class=“resultsLeftSide”><p align=“center”>‘.$CrossCutAngleLeftSide.’
</p></td>
<td class=“resultsLeftSide”><p align=“center”>‘.$BevelAngleLeftSide.’</p></td>
<td rowspan=“2” class=“resultsRightSide”>‘.$CutImageFinal.’</td>
</tr><tr bordercolor=“#CCCCCC” bgcolor=“#FFFFFF”>
<td bgcolor=“#E2EFFF” class=“resultsRightSide”><p align=“center”>
<a href=“#” title=“Video - Right Trim Side”
onclick=“popuppixwin=window.open
(\‘videoclip.php?Tool=‘.$Tool.’&amp;TrimSide=Right&amp;RBevelAngle=‘.
$BevelAngleRightSide.’&amp;RMiterAngle=‘.$CrossCutAngleRightSide.’&amp;
SpringAngle=‘.$SpringAngle.’&amp;SideAgainstFenceRightSide=‘.$SideAgainst
FenceRightSide.’&amp;
SideToKeepRightSide=‘.$SideToKeepRightSide.’&amp;RoomName=‘.$RoomName
.’&amp;WallNum=‘.$WallNum.’&amp;
Piece=‘.$TrimPiece.’&amp;VideoClipTitle=Video - Right Trim Side\’,
\‘pixwin\’,\‘toolbar=no,location=no,
directories=no,status=no,menubar=no,addressbar=no,scrollbars=no,resizable=no,
copyhistory=yes,width=500,height=340\’); popuppixwin.focus( ); return false;”>
<img src=“images/videoclipartR.gif” alt=“Video” width=“28” height=“32”
border = “0”/></a></p></td>
<td bgcolor=“#E2EFFF” class=“resultsRightSide”>
<p align=“center”>‘.$TrimSideRightSide.’</p></td>
<td bgcolor=“#E2EFFF” class=“resultsRightSide”>
<p align=“center”>‘.$SideAgainstFenceRightSide.’</p></td>
<td bgcolor=“#E2EFFF” class=“resultsRightSide”>
<p align=“center”>‘.$SideToKeepRightSide.’</p></td>
<td bgcolor=“#E2EFFF” class=“resultsRightSide”>
<p align=“center”>‘.$CrossCutAngleRightSide.’ </p></td>
<td bgcolor=“#E2EFFF” class=“resultsRightSide”>
<p align=“center”>‘.$BevelAngleRightSide.’</p></td>
</tr></table></div></td></tr></table></div></td></tr>
</table>’;

Reports are either saved digitally to electronic devices 1416, 1417, 1418, or printed from a printer 1419 on sheets of paper 1422 or transmitted to another computer over the internet or to other storage devices such as but not limited to USB media stick, Compact Flash Card or Smart Media, CDROM disk, floppy disk, or DVD disk, BlueRay disk, or any other data storage media.

The computer system 1403 may be replaced by a tablet 1415 or kiosk (not shown) that may have other input means such as a touch screen display for data input. The system allows the user a variety of ways of data input and provides the portability to implement the system in a variety of locations where space is limited, the implementation of which are apparent to one of ordinary skill in the art.

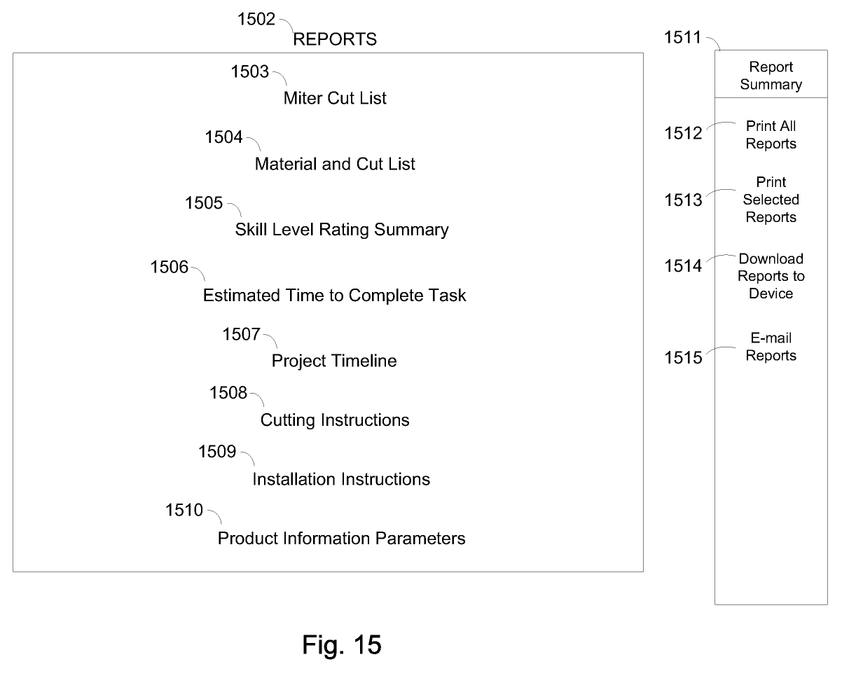

FIG. 15 shows the Reports 1502 screen showing available reports that is system generates and makes available to the user. Header information such as project title, project name, project leader, or a combination thereof may be received by the system and included on top of each report. Reports include but are not limited to a Miter Cut List 1503, Material and Cost List 1504, Skill Level Rating Summary 1505, Estimated Time to Complete Tasks 1506, Project Timeline 1507, Cutting Instructions 1508, Installation Instructions 1509, and Product Information Parameters 1510. An exemplary web based code responsible for generating reports is illustrated in Table 4.0.

Under the Reports Summary 1511, reports may be printed all at once by selecting the Print All Reports 1512 button, or individually by selecting the Print Selected Reports 1513 button. Reports may also be downloaded to a device 1514 such as a USB media stick, Compact Flash, Smart Card, Personal Digital Assistant (PDA), mobile phone, or computer. Furthermore, reports may be transmitted electronically 1515 by Email, FTP, or any other electronic means including over the Internet.

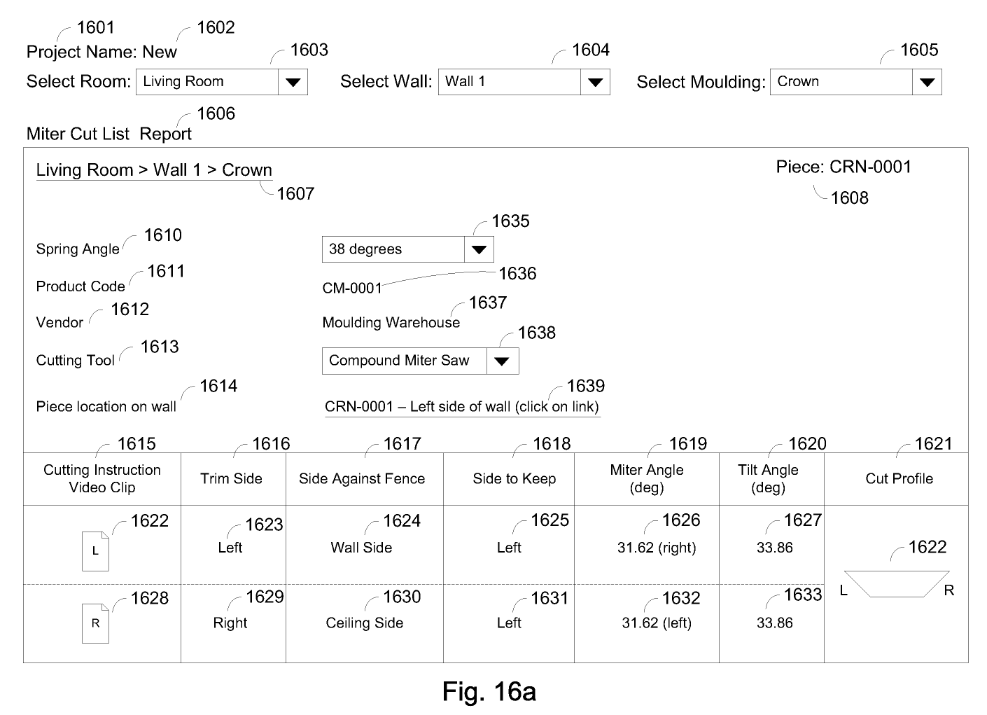

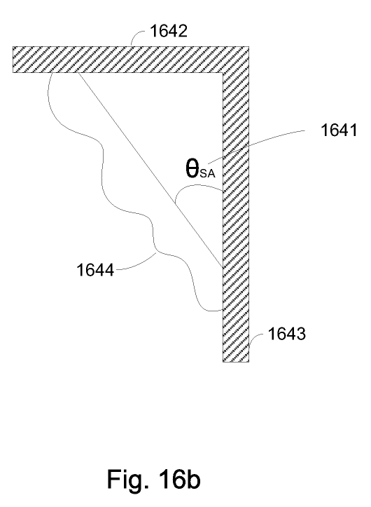

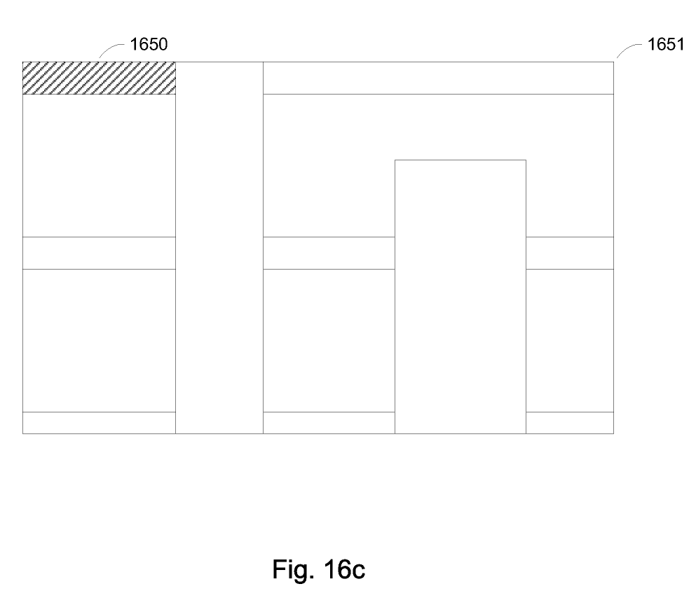

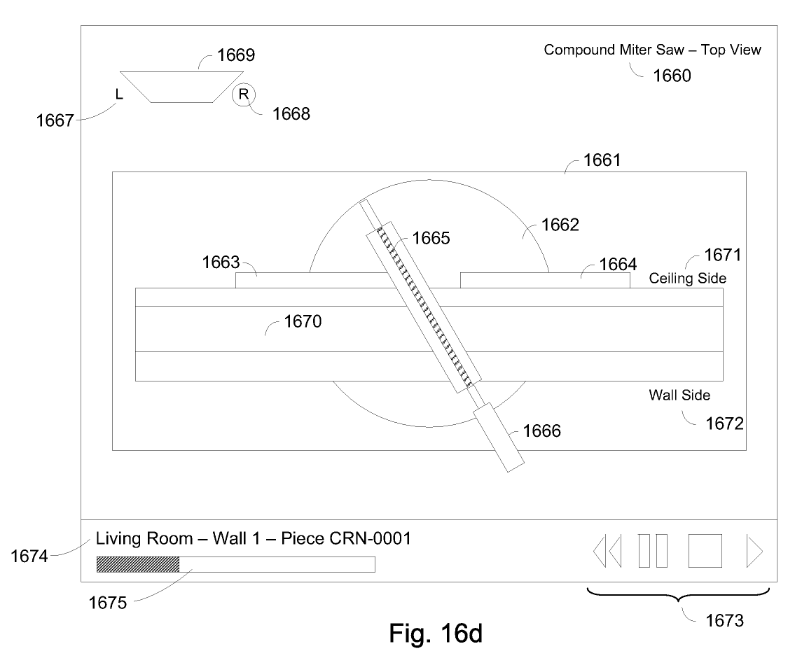

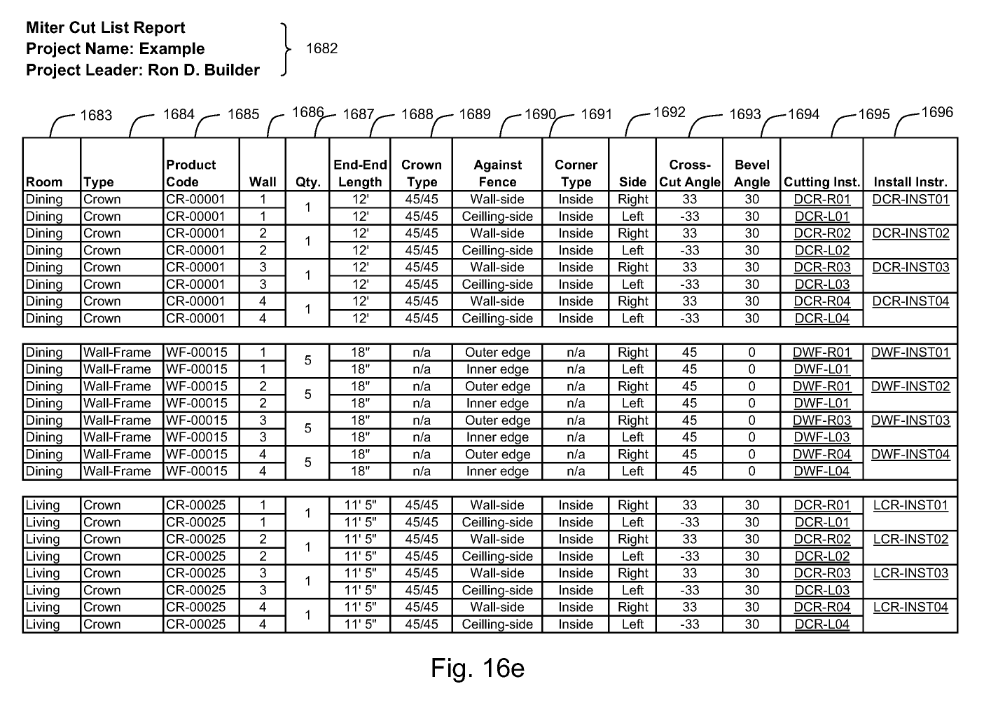

An example of a Miter Cut List Report generated by the system is illustrated in FIG. 16a. Referring to FIG. 16a, the project name 1601 and report title is part of the header information mentioned earlier and have a value of New 1602 and Miter Cut List Report 1606, respectively. The system can filter out the Miter Cut List Report for specific rooms, walls, and molding type based on the input received from the drop down boxes 1603, 1604, and 1605, respectively. Examples of choices of rooms available in the select room drop down box 1603 include, but are not limited to, Living Room, Dining Room, Bedroom, Bathroom, or Other Room. Examples of choices of walls available in the select wall drop down box 1604 include, but are not limited to, Wall 1, Wall 2, Wall 3, . . . , Wall n, where n is a positive number greater than zero. Examples of choices of molding available in the select molding drop down box 1605 include, but are not limited to, Crown, Chair Rail, Base Board, or Other Molding. The system provides a status of the currently selected items 1607 which is dependent upon the selection of room, wall, and molding as indicated by the select drop down boxes 1603, 1604, and 1605, respectively. A multiple listing of rooms, walls and molding can be generated in the Miter Cut List Report 1606 by the system that provides detailed miter cut information described above. The Miter Cut List Report 1606 generates the multiple listing of rooms, walls, and molding which can be itemized by Piece 1608 number. Included in the Miter Cut List Report 1606 are a set of parameters such as, but not limited to, Spring Angle 1610, Product Code 1611, Vendor 1612, Cutting Tool 1613, Piece Location on Wall 1614, Cutting Instruction Video Clip 1615, Trim Side 1616, Side Against Fence 1617, Side to Keep 1618, Miter Angle (deg) 1619, Tilt Angle (deg) 1620, and Cut Profile 1621.

Referring to FIG. 16b, Spring Angle 1610 is represented by θ_{SA} 1641, which is the angle between a vertical wall 1643 standing perpendicular to the ceiling 1642 and crown molding 1644. Typically, spring angles associated with crown molding is offered in various angles such as, but not limited to, 38°, 45° or 52°.

Referring back to FIG. 16a, the system is capable of receiving various spring angles from the drop down box 1635. The drop down box 1635 shows a spring angle selection of 38 degrees. The system can receive conventional spring angles such as, but not limited to, 38°, 45° or 52° as well as custom defined spring angles. Those of ordinary skill in the art would recognize the term “spring angle” may be alternatively known as crown angle, θ_{crown}, crown-wall angle, or other similar phraseology. Based on the spring angle selected from the drop down box 1635, the system can generate a set of corresponding miter angles 1619 and tilt angles 1620 for the Miter Cut List Report 1606. Those of ordinary skill in the art would recognize the term “miter angle” may be alternatively known as cross-cut angle, θ_{cross-cut} or fence angle, and may be used interchangeably. Similarly, those of ordinary skill in the art would recognize that the term “tilt angle” may be alternatively expressed as bevel angle, θ_{bevel} or slant angle, and may be used interchangeably. Product Code 1611 is the vendor's product code for the decorative trim and is retrieved from a local computer or on a computer connected to the Internet at home improvement web sites. Vendor 1612 is the supplier name supplying the decorative trim and is retrieved from a local computer or on a computer connected to the Internet at home improvement web sites.

Cutting Tool 1613 is comprised of a list of tools used for cutting crown molding which may be selected from the drop down box 1638. Examples of the selection of cutting tools listed in the drop down box 1638 include, but are not limited to, Compound Miter Saw, Double-bevel Compound Miter Saw, Table Saw, and Miter Box. For each cutting tool selected from the drop down box 1638, the system automatically generates a customized Miter Cut List Report 1606 that can have different Cutting Instruction Video Clips 1615, Trim Side 1616 values, Side Against Fence 1617 values, Side to Keep 1618 values, Miter Angles 1619 and Tilt Angles 1620 for each selected tool.

Piece location on wall 1614 in FIG. 16a represents a hyperlink to a graphical representation of the currently displayed Piece 1608. In this example, the value of the piece location is CRN-0001—Left side of wall (click on link) 1639. Selecting the link will bring up a graphical display illustrated in FIG. 16c where FIG. 16c illustrates the graphical representation of a molding piece 1650 and its relative location with respect to other objects in work space 1651. The location of the molding piece 1650 shown in FIG. 16c is determined by the system from input values received during the wall configuration step shown in FIG. 5a and FIG. 5b.

Referring back to FIG. 16a, the column titled Cutting Instruction Video Clip 1615 may comprise animated or video clip hyperlinks. The hyperlink for the left side of the decorative trim Piece 1608 is represented by L 1622 while the hyperlink for the right side of the decorative trim Piece 1608 is represented by R 1628. When L 1622 or R 1628 hyperlink is selected, the system can generate and output an instructional animated or video clip of how to set up the Cutting Tool 1613 for the set of parameters illustrated in FIG. 16a.

In FIG. 16d, a video clip output for Living Room-Wall 1-Piece CRN-0001 1674 is generated by the system in response to the selected hyperlink R 1628 shown in FIG. 16a. Referring to FIG. 16d, the video clip may comprise video instructions of how to set up the cross-cut angle and bevel angle settings for the selected cutting tool Compound Miter Saw 1660, a cut profile 1669 of the decorative trim piece having left side L 1667 and right side R 1668, a cutting tool area 1661 of the Compound Miter Saw 1660 as viewed from the top, a base 1662 capable of being rotated, a sample piece of molding 1670 used to demonstrate the set up and cut instructions, a left fence 1663 and a right fence 1664 for placing the sample piece of molding 1670 against, notations for the Ceiling Side 1671 and Wall Side 1672 of the sample piece of molding 1670, a circular saw blade 1665 used for cutting the sample piece of molding 1670, a handle 1666 for rotating the base 1662, a set of video playback controls 1673 for stopping, starting, rewinding, forwarding or pausing video, and a video progress indicator 1675 for displaying the status of the video playback.

Referring back to FIG. 16a, Trim Side 1616 represents the side of the decorative trim Piece 1608 that the other parameters on the same row are referring to and can be either Left 1623 or Right 1629. Side Against Fence 1617 represents the side of the decorative trim Piece 1608 that is against the miter saw fence. Valid values for Side Against Fence are wall side and ceiling side. Side Against Fence 1617 for Trim Side Left 1623 and Right 1629 have a value of Wall Side 1624 and Ceiling Side 1630, respectively. Side to Keep 1618 represents the side of the decorative trim Piece 1608 to be kept after it has been cut into two pieces. Valid values for Side to Keep 1618 are left and right. Side to Keep 1618 for Trim Side Left 1623 and Right 1629 have a value of Left 1625 and Left 1631, respectively.

Referring again to FIG. 16a, Miter Angle 1619 or Cross-Cut angle θ_{cross-cut} for crown molding is calculated using the Eq. (4):

θ_{cross-cut}=180/π*arctan(sin θ_{crown}/tan θ_{wall}), (degrees) (4)

wherein, θ_{crown} or θ_{Spring Angle} is converted to radians and is defined by the product's spring angle type (e.g., 38°/52° or 45°/45°) which is the angle between a wall 1643 and crown molding 1644 as illustrated in FIG. 16b, and θ_{wall} is the angle in radians between two adjacent walls. In FIG. 16a, for example, Miter Angle 1619 for Trim Side Left 1623 and Right 1629 have a value of 31.62 (right) 1626 and 31.62 (left) 1632, respectively, in which the direction in parentheses indicates the position of the handle 1666 shown in FIG. 16d relative to vertical center position of the base 1662 also shown in FIG. 16d.

Referring again to FIG. 16a, Tilt Angle 1620 or Bevel angles, θ_{bevel} for crown molding is calculated using the Eq. (5):

θ_{bevel}=90−[180/π*arctan(tan θ_{wall}/tan θ_{cross-cut})], (degrees) (5)

wherein, θ_{cross-cut} is the cross-cut angle determine previously, and θ_{wall} is the angle between the intersection of two adjacent walls. In FIG. 16a, for example, Tilt Angle 1620 for Trim Side Left 1623 and Right 1629 have a value of 33.86 1627 and 33.86 1633, respectively. Cut Profile 1621 is the front view outline 1622 of decorative trim Piece 1608 after it has been cut. The Cut Profile 1621 may have other profiles, not shown, which represents the decorative trim Piece 1608 having a different set of parameters.

FIG. 16e illustrates an example of an alternate report configuration of the Miter Cut List Report generated by the system. The top of the Miter Cut List report shows the Report Name, Project Name and Project Leader 1682 which is part of the header information mentioned earlier. The report also includes Room 1683, Type 1684, Product Code 1685, Wall 1686, Quantity 1687, End-End Length 1688, Crown Type 1689, Against Fence 1690, Corner Type 1691, Side 1692, Cross-Cut Angle 1693, Bevel Angle 1694, Cutting Instructions 1695, and Installation Instructions 1696.

Room 1683 specifies the room type as defined in FIG. 3. Type 1684 specifies the decorative trim type which may include Crown, Wall Frame, Base Board, Bead Board, or any other decorative trim.

Product Code 1685 is the vendor's product code for the decorative trim and is retrieved from a local computer or on a computer connected to the Internet at home improvement web sites.

Wall 1686 is the wall number as defined in FIG. 4b and FIG. 4c.

Quantity 1687 is the number of decorative trim pieces required for a particular miter cut setting.

End-End Length 1688 is the final length of the decorative trim that is to be cut. For example, the End-End Length 1688 for a wall frame decorative trim is based on the wall width such as the widths 437, 471 and 592 as illustrated in FIGS. 4b, 4c and 5c, respectively.

Crown Type 1689 is the angle of the crown as specified by the vendor such as 45/45 or 52/38.

Against Fence 1690 is the side of the decorative trim that is against the miter saw fence. For example, for crown molding, Against Fence 1690 is designated as either Wall-side or Ceiling-side.

Corner Type 1691 specifies whether the corner is inside or outside, depending on how the walls are configured as defined in FIG. 4b and FIG. 4c.

Side 1692 is the side the miter cross-cut angle is positioned. Valid positions are left, right, or zero.

Cross-Cut Angle 1693 is the miter saw's cross-cut setting. Valid range for Cross-Cut Angle 1613 is −45 degrees to +45 degrees. See Eq. (4).

Bevel Angle 1694 is the miter saw's bevel angle setting. Valid range for Bevel Angle 1694 is 0 degrees to 45 degrees. See Eq. (5).

Cutting Instructions 1695 is a hyperlink to the cutting instructions for specific cut parameters, i.e., Crown Type 1689, Against Fence 1690, Corner Type 1691, Side 1692, Cross-Cut Angle 1693, and Bevel Angle 1694.

Installation Instructions 1696 is a hyperlink to the installations instructions for specific cut parameters, i.e., Crown Type 1689, Against Fence 1690, and Side 1692.

Calculation of miter cut angles and wall-frame dimensions: Cross-Cut angle θ_{cross-cut}, which is also know as Miter Angle, is calculated using the Eq. (4), wherein, θ_{crown} or θ_{Spring Angle} is defined by the product (e.g., 38°/52° or 45°/45°) which is the angle between a wall 1643 and crown molding 1644 as illustrated in FIG. 16b, and θ_{wall} is the angle between the of two adjacent walls.

Bevel angles, θ_{bevel}, for crown molding are calculated using the Eq. (5), wherein, θ_{cross-cut} is the the cross-cut angle determine previously, and θ_{wall} is the angle between the intersection of two adjacent walls.

Calculation of Wall Frame cut width, Wall-frame width, W_{wall frame}, is calculated using Eq. (3).

Calculation of Wall Frame miter cut angles for Stairs, Wall-frame angles, θ_{accute} and θ_{obtuse}, for stairs are calculated using Eq. (1) and Eq. (2), respectively.

Calculation of the starting position for Bead Board is determined by Eq. (6):

Bead Board Starting Position=(w−n*x)/2 (6)

wherein, w is the wall width, x is the pitch between vertical lines, and n is the number of paired vertical lines contained in the bead board.

There is no limit of how many cutting or installation instructions are generated by the system. For example, a room of four walls containing crown molding, wall frames, base boards, and chair rails will have in excess of fifty cutting instructions per room and in excess of twenty five installation instructions generated by the system.

In another example, for two or more rooms which have four walls per room comprising of crown molding, wall frames, base boards, and chair rails, the system generates a minimum of one hundred cutting instructions, and a minimum of fifty installation instructions.

For Nᵣ rooms which have 4 walls per room comprising of crown molding, wall frames, base boards, and chair rails, the system generates a minimum of 50*Nᵣ cutting instructions, and a minimum of 25*Nᵣ installation instructions, wherein Nᵣ is the total number of rooms.

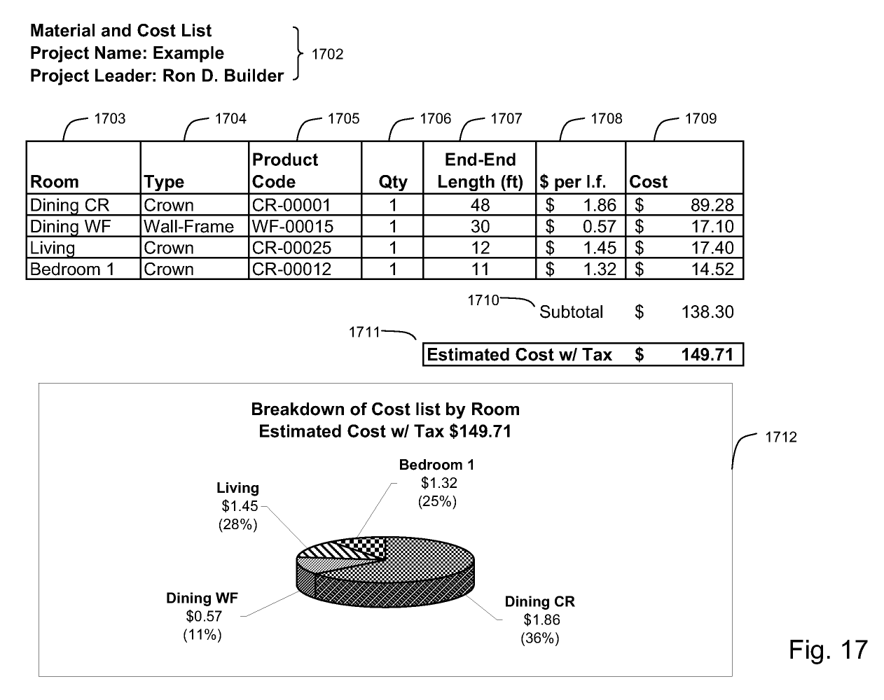

FIG. 17 illustrates an example of the material and cost list report. This report summarizes the decorative trim material and cost by room. The top of the Material and Cost List report shows the Report Name, Project Name and Project Leader 1702. The report also includes Room 1703, Type 1704, Product Code 1705, Quantity 1706, End-End Length 1707, $ per l.f. 1708, Cost 1709, Subtotal 1710, Estimated Cost with Tax 1711, Graphical Chart of the Breakdown of Cost list by Room 1712.

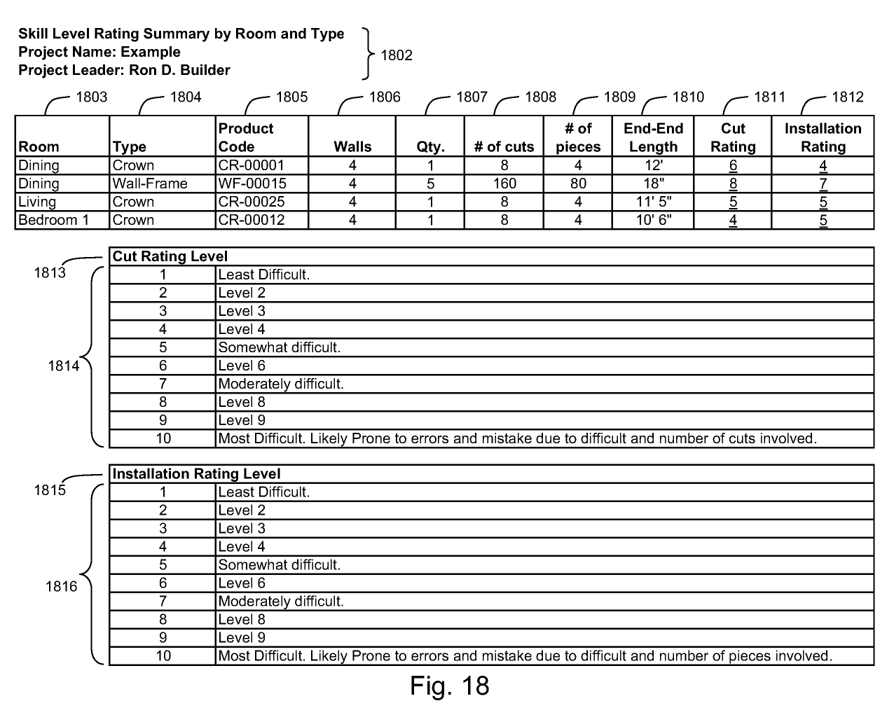

FIG. 18 illustrates the skill level and complexity rating report. This report summarizes the skill level rating by room and type. The top of the skill level and complexity rating report shows the Report Name, Project Name and Project Leader 1802. The report also includes Room 1803, Type 1804, Product Code 1805, Walls 1806, Quantity 1807, # of cuts 1808, # of pieces 1809, End-End Length 1810, Cut Rating 1811, Installation Rating 1812, a breakdown of the Cut Rating Level 1813, and a breakdown of the Installation Rating Level 1815. Cut Rating 1811 and Installation Rating 1812 have assigned values, 1814 and 1816 respectively, ranging from 1 to 10 with 1 being the least difficult and 10 being the most difficult, and correspond to the skill levels shown in the Cut Rating Level 1813 and Installation Rating Level 1815 tables in FIG. 18. The values assigned to Cut Rating 1811 and Installation Rating 1812 is calculated from weighted averages of multiple cut and installation factor ratings as described below.

Calculating Cut Rating, Cut Rating, R_{c}=weighted average of multiple cut factor ratings:

Number of cuts, N_{cc}

Type of cuts, T_{cc}

Length of material, L_{mc}

Weight of material, L_{wc}

Type of tools required, T_{tc}

Number of tools required, T_{nc}

User feedback, U_{fc}

R_{c}=[a*N_{cc}+b*T_{cc}+c*L_{mc}+d*L_{wc}+e*T_{tc}+f*T_{nc}+g*U_{fc}]/[a+b+c+d+e+f+g] (7)

where a, b c, d, e, f, and g are weighted coefficients, and N_{cc}, T_{cc}, L_{mc L}_{wc}, T_{tc}, T_{nc}, and U_{fc} factors are rated according to Table 5.0 shown below. Valid ranges for each factor are also shown in Table 5.0. These ratings are exemplary only and may be modified by one of ordinary skill in the art. In the present invention, the system determines the Cut Rating, R_{c}, using Eq. (7) comprising of pre-determined weighted coefficients and N_{cc}, T_{cc}, L_{mc}, L_{wc}, T_{tc}, T_{nc}, and U_{fc} factors received by the system.

TABLE 5.0
Cut Complexity Parameters

| Cut Factor | Range | Factor Rating |
|---|---|---|
| Number of Cuts, N_{cc} | 0-5 | 1 |
| | 6-10 | 2 |
| | 11-15 | 3 |
| | 16-20 | 4 |
| | 21-25 | 5 |
| | 26-30 | 6 |
| | 31-35 | 7 |
| | 36-40 | 8 |
| | 41-49 | 9 |
| | >50 | 10 |
| Type of Cuts, T_{cc} | Chair Rail | 1 |
| | Base Boards | 2 |
| | Bead Boards | 2 |
| | Wall Frame | 4 |
| | Stairway Wall Frames | 6 |
| | Crown Molding | 8 |
| | Façade | 10 |
| Length of material, L_{mc} | Less than 2 feet | 1 |
| | 2-4 feet | 3 |
| | 4-8 feet | 7 |
| | >8 feet | 10 |
| Weight of material, L_{wc} | Less than 1 pound | 1 |
| | 1-3 pounds | 3 |
| | 3-10 pounds | 7 |
| | >10 pounds | 10 |
| Type of tools required, T_{tc} | Table Saw | 2 |
| | Circular Saw | 2 |
| | Miter Saw | 7 |
| | Fixed Router | 8 |
| | Plunge Router | 9 |
| Number of tools required, T_{nc} | 1 tool | 1 |
| | 2 tools | 3 |
| | 3 tools | 5 |
| | >3 tools | 8 |
| User feedback, U_{fc} | Very Easy | 1 |
| | Easy | 2 |
| | Somewhat Easy | 3 |
| | Somewhat Difficult | 6 |
| | Difficult | 7 |
| | Very Difficult | 10 |

Calculating Installation Rating, Installation Rating, Rᵢ=weighted value of multiple installation factor ratings:

Number of Pieces, Nₚᵢ

Type of install, Tᵢᵢ

Length of material, Lₘᵢ

Weight of material, L_{wi}

Type of tools required, Tₜᵢ

Number of tools required, Tₙᵢ

User feedback, U_{fii}

Rᵢ=[h*Nₚ+i*Tᵢᵢ+j*Lₘᵢ+k*L_{wi}+l*Tₜᵢ+m*Tₙᵢ+n*U_{fi}]/[h+i+j+k+l+m+n] (8)

where h, i, j, k, l, m, and n are weighted coefficients, and Nₚᵢ, Tᵢᵢ, Lₘᵢ, L_{wi}, Tₜᵢ, Tₙᵢ, and U_{fi} factors are rated according to Table 6.0 shown below. Valid ranges for each factor are also shown in Table 6.0. These ratings are exemplary only and may be modified by one of ordinary skill in the art. In the present invention, the system determines the Cut Rating, R_{c}, using Eq. (8) comprising of pre-determined weighted coefficients and Nₚᵢ, Tᵢᵢ, Lₘᵢ, L_{wi}, Tₜᵢ, Tₙᵢ, and U_{fi} factors received by the system.

TABLE 6.0
Installation Complexity Parameters

| Cut Factor | Range | Factor Rating |
|---|---|---|
| Number of Pieces, Nₚᵢ | 0-5 | 1 |
| | 6-10 | 2 |
| | 11-15 | 3 |
| | 16-20 | 4 |
| | 21-25 | 5 |
| | 26-30 | 6 |
| | 31-35 | 7 |
| | 36-40 | 8 |
| | 41-49 | 9 |
| | >50 | 10 |
| Type of install, Tᵢᵢ | Chair Rail | 1 |
| | Base Boards | 2 |
| | Bead Boards | 2 |
| | Wall Frame | 4 |
| | Stairway Wall Frames | 6 |
| | Crown Molding | 8 |
| | Facade | 10 |
| Length of material, Lₘᵢ | Less than 2 feet | 1 |
| | 2-4 feet | 3 |
| | 4-8 feet | 7 |
| | >8 feet | 10 |
| Weight of material, L_{wi} | Less than 1 pound | 1 |
| | 1-3 pounds | 3 |
| | 3-10 pounds | 7 |
| | >10 pounds | 10 |
| Type of tools required, Tₜᵢ | Finishing Nail Gun | 2 |
| | Air Compressor | 2 |
| | Staple Gun | 2 |
| Number of tools required, Tₙᵢ | 1 tool | 1 |
| | 2 tools | 3 |
| | 3 tools | 5 |
| | >3 tools | 8 |
| User feedback, U_{fi} | Very Easy | 1 |
| | Easy | 2 |
| | Somewhat Easy | 3 |
| | Somewhat Difficult | 6 |
| | Difficult | 7 |
| | Very Difficult | 10 |

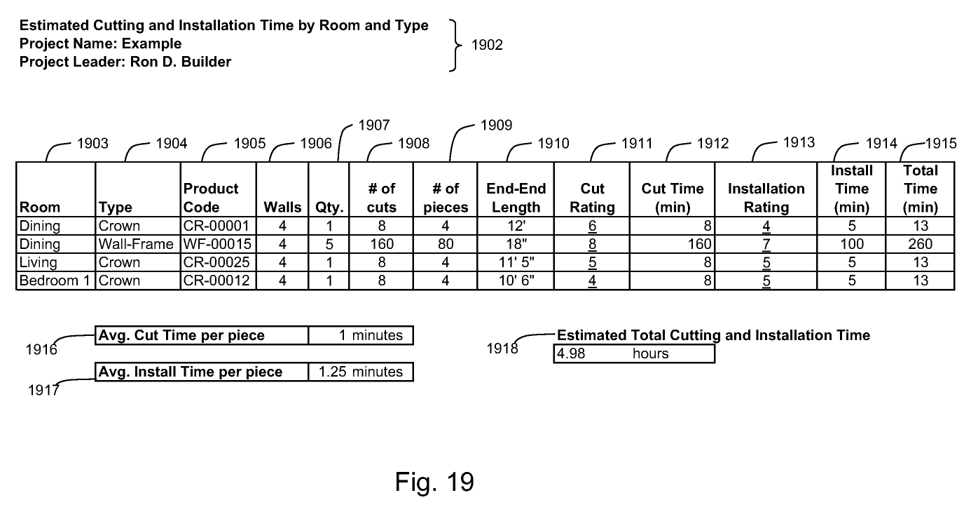

FIG. 19 illustrates an example of the estimated cutting and installation time report. This report summarizes the estimated cutting and installation time by room and type. The top of the estimated cutting and installation time report shows the Report Name, Project Name and Project Leader 1902. The report also includes Room 1903, Type 1904, Product Code 1905, Walls 1906, Quantity 1907, # of cuts 1908, # of pieces 1909, End-End Length 1910, Cut Rating 1911, Cut Time 1912, Installation Rating 1913, Install Time 1914, Total Time 1915, Average Cut Time per piece 1916, Average Install Time per piece 1917, and Estimated Total Cutting and Installation Time 1918.

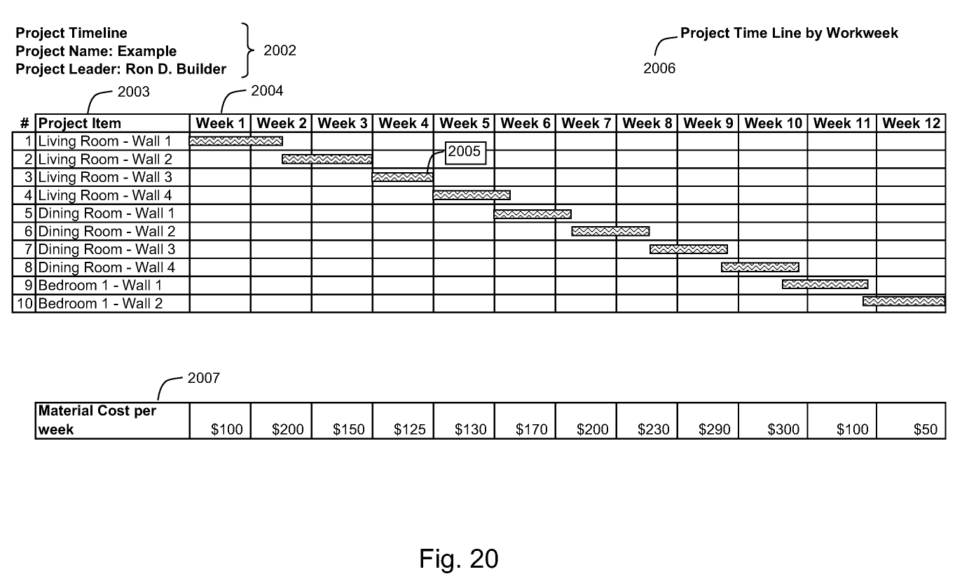

FIG. 20 illustrates an example of a project timeline report. This report, a Project Time Line by Workweek 2006, summarizes the project timeline by room and by wall number. The top of the project timeline report shows the Report Name, Project Name and Project Leader 2002. The report also includes Project Item 2003, Week Number 2004, and Material Cost by week number 2007. A work schedule of items projected start and completion dates are indicated by bars 2005 below the Week numbers 2004.

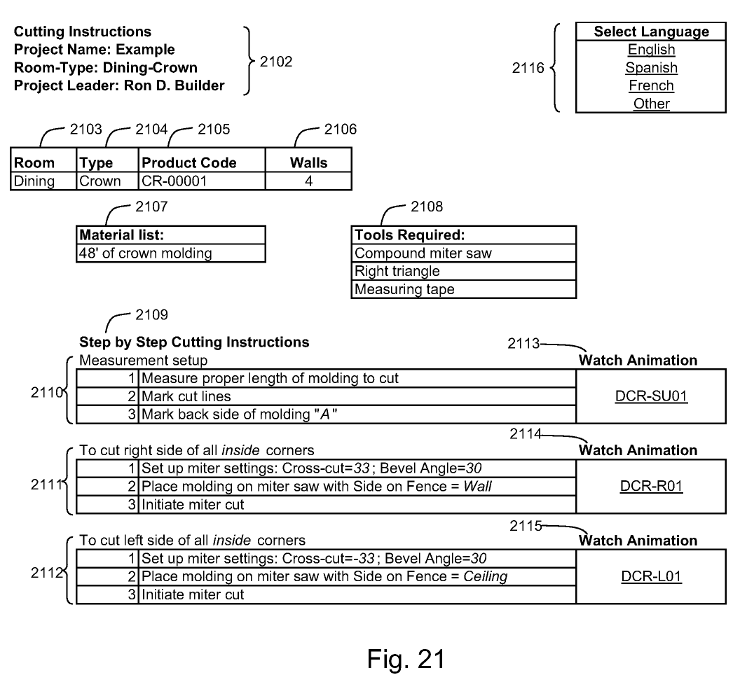

FIG. 21 illustrates an example of a customized cutting instructions report. This report summarizes the cutting instructions for a room and a type of decorative trim. The top of the project timeline report shows the Report Name, Project Name, Room-Type, and Project Leader 2102. The report also includes Room 2103, Type 2104, Product Code 2105, Walls 2106, Material List 2107, Tools Required 2108, Step by Step Cutting Instructions 2109, a breakdown of cutting instructions by steps 2110, 2111, 2112, and a link to animated cutting instructions 2113, 2114, 2115 for each step 2110, 2111, 2112, respectively. The system further provides cutting instructions in various languages. In the Select Language 2116, links to various cutting instructions in different languages are provided by the system to the user. By default, the Select Language 2116 is English.

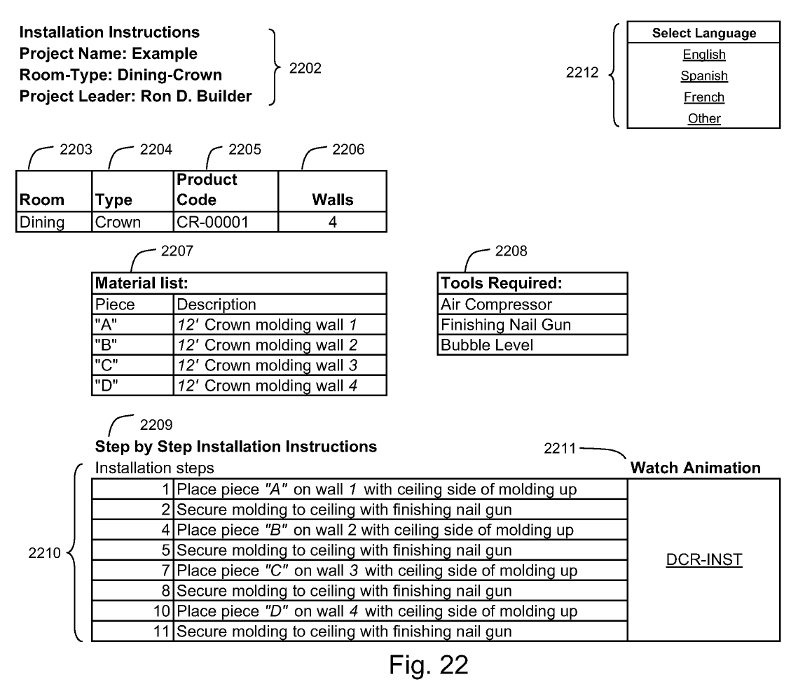

FIG. 22 illustrates an example of a customized installation instructions report. This report summarizes the installation instructions for a room and a type of decorative trim. The top of the project timeline report shows the Report Name, Project Name, Room-Type, and Project Leader 2202. The report also includes Room 2203, Type 2204, Product Code 2205, Walls 2206, Material List 2207, Tools Required 2208, Step by Step installation Instructions 2209, a breakdown of installation instructions by steps 2210, and a link to animated installation instructions Watch Animation 2211. The system further provides installation instructions in various languages. In the Select Language 2212, links to various installation instructions in different languages are provided by the system to the user. By default, the Select Language 2116 is English.

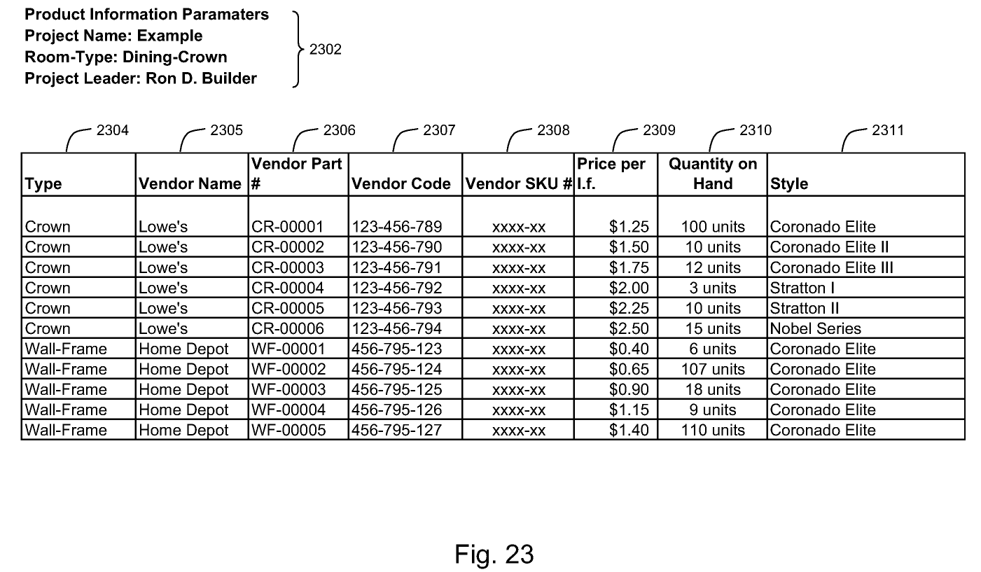

FIG. 23 illustrates an example of the product information report. This report summarizes product information parameters by type of decorative trim. The top of the product information parameters report shows the Report Name, Room-Type, Project Name and Project Leader 2302 which. The report also includes Type 2304, Vendor Name 2305, Vendor Code 2306, Vendor Code 2307, Vendor SKU 2308, Price per Linear Foot 2309, Quantity on Hand 2310, and Style 2311.

The product information's database reside in a storage device accessed by the system either remotely on a server or locally on a computer system's storage medium such as a hard disk drive, CD-Rom, or related similar storage medium. Furthermore, the product information database may be automatically and routinely updated by a separate computer system as new information related to cost, styles, and quantity on hand changes.

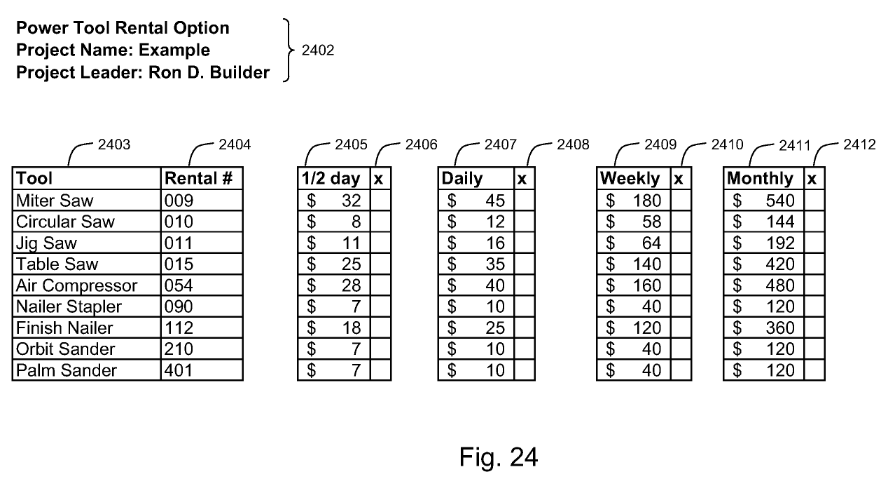

FIG. 24 illustrates an example of the power tools rental option screen report. This report summarizes power tool rental options by type of tool and may used to determine additional project cost based on the cost and number of tools rented. The top of the power tools rental parameters report shows the Report Name, Room-Type, Project Name and Project Leader 2402. The report also includes Tool 2403, Rental Number 2404, cost of half day rental rates 2405, selection boxes for half day rentals rates 2406, cost of daily rental rates 2407, selection boxes for daily rental rates 2408, cost of weekly rental rates 2409, selection boxes for weekly rental rates 2410, cost of monthly rental rates 2411, and selection boxes for monthly rental rates 2412.

The power tools rental database reside in a storage device accessed by the system either remotely on a server or locally on a computer system's storage medium such as a hard disk drive, CD-Rom, or related similar storage medium. Furthermore, the power tools rental database may be automatically and routinely updated by a separate computer system as new information related to rental cost and tool availability changes.

FIG. 25 illustrates pre-defined decorative trim elements for a façade's Style Part number described in the Façade Library according to one embodiment of the invention. Each façade structure can be described in terms of basic and distinct decorative trim elements. The façade structure 2503 for a given Façade Style Part number 2502 is comprised of a Crown 2504, Mid 2505 section, Arch 2506, first size wall frame WF 1 2507, Chair Rail 2508, second size wall frame WF2 2509, and Base 2510. Each element has an associated part number, cost per unit, and properties information such as length, width, weight, etc. Once a façade structure is defined in terms of its decorative trim elements, it may be uploaded to the system and saved as a pre-defined style with a corresponding part number. In addition to defining the basic decorative trim elements for a façade structure, customized cutting and installation instructions may be defined and uploaded to the system corresponding to the pre-defined style's part number. It should be noted that pre-defined façade structures may be uploaded to the system via a network connection such as a local area network (LAN) or wide area network (WAN), or wireless connection, and shared by multiple users of the system.

A key aspect of the façade structure is scalability. Scalable façade structures enable the user to drag & drop and scale the facade elements into the Work area 542 shown in FIG. 5 in order to fit the room dimensions specified by the user. When a façade is scaled, the system automatically determines cost, materials, miter cut settings, and installation instructions based on the façade's scaled dimensions. This provides the user the instant and necessary information to understand the project costs, materials, cutting, and installation requirements associated with this façade structure.

Another embodiment of the invention that uses several parameters already presented is the system's ability to offer pre-determined project recommendations of cutting and installation instructions based on the user's budget and skill requirements. For example, the system may accept the user's budget and skill level constraints for a project as input parameters, and use these parameters in conjunction with the cost of materials, cutting complexity rating, and installation complexity rating to determine a suitable project that meets the user's pre-defined constraints. The system would then generate the necessary reports to accommodate the user's budget and skill level constraints as discussed above.

The system described above may be implemented fully in an animated enabled, object-oriented programming (OOP) language such as Javascript, PHP, ASP, Adobe's Flash® ActionScript or equivalent programming language capable of associating objects with animated movie clips. The system may utilize databases such as MySQL, Oracle Database, Informix, dBase or any suitable databases for storing, managing, and providing content related data to the system. Decorative trim objects may be created with 3-dimensional tools and manipulated through ActionScript commands to achieve the intended custom miter cutting and installation demonstrations. For example, when defining a miter cut setting in an animated instructional movie clip, the system determines the custom miter cut settings and lengths based on the user's input room dimensions, and applies these custom miter cut settings to the movie clip. Similarly, installation instructions may be customized in accordance to the materials required for installation. For example, the system identifies individual materials needed by piece number 628 as shown in FIG. 22, and applies these piece numbers to the installation movie clip. Moreover, miter cut angles, crown type, fence and other settings may be customized and consolidated by ActionScript commands into single report for displaying, printing or storing. An exemplary web based programming code responsible for the room set up step, wall configuration step, and miter cut report step are illustrated in Table 3.0, Table 4.0, and Table 5.0 respectively.

While specific embodiments of the present invention have been presented and described, further modifications and enhancements will occur to those skilled in the art. It is understood that the invention is not limited to the particular configuration shown and it is intended for the claims to cover all modifications which do not depart from the spirit and scope of this invention.

Other embodiments and modifications of the present invention may occur to those of ordinary skill in the art in view of these teachings. Accordingly, the invention is to be limited only by the following claims which include all other such embodiments and modifications when viewed in conjunction with the above specifications and accompanying drawings.

I claim:

1. A method comprising the step of:
selecting one or more rooms;
defining one or more walls for each of the one or more rooms;
defining a plurality of adjacent wall angles, a plurality of wall object angles, a plurality of spring angles, and combinations thereof for each of the one or more walls;
determining a plurality of angle settings based on the plurality of wall angles, plurality of wall object angles, a plurality of spring angles and combinations thereof for each of the one or more walls; and
generating a plurality of self-help cutting instructions having the plurality of angle settings arranged by the one or more walls for each of the one or more rooms.

2. The method of claim 1, wherein the self-help cutting instructions further comprises a plurality of trim side settings, side against fence settings, side to keep settings, a plurality of miter angle settings, a plurality of bevel angle settings, and a plurality of cut profiles.

3. The method of claim 1, wherein the angle settings are for a compound miter saw, a double bevel miter compound miter saw, or a box saw.

4. The method of claim 1, wherein each of the angle settings is comprised of a miter angle and bevel angle.

5. The method of claim 1, wherein the self-help cutting instructions include a plurality of animated or video clips demonstrating how to cut a left side portion and a right side portion of a piece of decorative trim.

6. The method of claim 5, wherein the piece of decorative trim comprises crown molding, chair rail, or base board.

7. The method of claim 1, wherein the self-help cutting instructions are step-by-step cutting instructions of a plurality of decorative trim.

8. The method of claim 7, wherein the plurality of decorative trim comprises a crown molding, chair rail, base board and combinations thereof.

9. A system comprising:
a computer or server capable of receiving inputs, wherein the inputs are comprised of a plurality of rooms, plurality of adjacent wall angles, a plurality of wall object angles, a plurality of spring angles, and combinations thereof;
a database, coupled to the computer, for storing the inputs received by the computer or server; and
a program operating on the computer or server capable of a) determining a plurality of angle settings based on the plurality of wall angles, plurality of wall object angles, a plurality of spring angles and combinations thereof for each of the one or more walls; and b) generating a plurality of self-help cutting instructions having the plurality of angle settings arranged by the one or more walls for each of the one or more rooms.

10. The system of claim 9, wherein the self-help cutting instructions comprises a plurality of trim side settings, side against fence settings, side to keep settings, a plurality of miter angle settings, a plurality of bevel angle settings, and a plurality of cut profiles.

11. The system of claim 9, wherein the angle settings are for a compound miter saw, a double bevel miter compound miter saw, or a box saw.

12. The method of claim 9, wherein each of the angle settings is comprised of a miter angle and bevel angle.

13. The system of claim 9, wherein the self-help cutting instructions include a plurality of animated or video clips demonstrating how to cut a left side portion and a right side portion of a piece of decorative trim.

14. The system of claim 13, wherein the piece of decorative trim comprises crown molding, chair rail, or base board.

15. The system of claim 9, wherein the self-help cutting instructions are step-by-step cutting instructions of a plurality of decorative trim.

16. The system of claim 15, wherein the plurality of decorative trim comprises a crown molding, chair rail, base board and combinations thereof.

17. The system of claim 9, wherein the database and the program are coupled to the computer or server over the Internet.

18. A computer program for implementing claim 1.

19. A computer program for implementing claim 9.
